(19) United States
(12) Patent Application Publication
(10) Pub. No.: US 2013/0117175 A1
(43) Pub. Date: May 9, 2013

(54) BAR CODED MONETARY TRANSACTION SYSTEM AND METHOD

(71) Applicant: PAYSCAN AMERICA, INC., Rancho Palos, CA (US)

(72) Inventor: Trevor Hanson, Sequim, WA (US)

(73) Assignee: PAYSCAN AMERICA, INC., RANCHO PALOS, CA (US)

(21) Appl. No.: 13/662,192

(22) Filed: Oct. 26, 2012

Related U.S. Application Data
(63) Continuation of application No. 13/304,074, filed on Nov. 23, 2011, now abandoned.
Application No. 13/304,074 is a continuation of application No. 12/363,665, filed on Jan. 30, 2009, now abandoned.
(60) Provisional application No. 61/025,246, filed on Jan. 31, 2008.
(60) Provisional application No. 61/044,427, filed on Apr. 11, 2008.

(51) Int. Cl. G06Q 20/14

(52) U.S. Cl. CPC G06Q 20/14
USPC 705/39

(57) ABSTRACT

An improved financial transaction device comprising bar-coded information incorporating one of a plurality of algorithmic signatures, the signature being configured to permit at least one party involved in a financial transaction to store pertinent data in a multi-organizational payment tracking database, wherein the signature comprises a payment tracking identifier capable of uniquely referencing a single financial transaction and some of the pertinent data. The transaction may correspond to a format signature which may be in the form of a unique pictographic image representing the arrangement of data on a financial device for comparison against a library or database of signatures for purposes of device recognition.

### RELATED APPLICATIONS

This application is a continuation application of U.S. application Ser. No. 13/304,074, filed Nov. 23, 2011, which is a continuation application of U.S. application Ser. No. 12/363,665, filed Jan. 30, 2009, which claims the benefit of priority under 35 U.S.C. §119(e) of U.S. Provisional Application No. 61/025,246 filed on Jan. 31, 2008 and U.S. Provisional Application No. 61/044,427 filed Apr. 11, 2008, the entire disclosure of which is hereby incorporated by reference herein and should be considered a part of this specification.

### FIELD OF THE INVENTION

The present inventions relate generally to improved systems and methods for performing electronic monetary transactions, and more specifically to improvements to monetary transactions involving the use of bar codes with algorithmic signatures, including bill payment transactions. The fundamentals of such inventive transactions are described in greater detail in U.S. Pat. No. 6,993,507 filed on Dec. 14, 2000, U.S. patent application Ser. No. 10/020,691 filed on Dec. 14, 2001, and U.S. patent application Ser. No. 11/932,048 filed on Oct. 31, 2007, all of which are expressly and entirely incorporated herein by reference as “Krouse/Meyer.”

### BACKGROUND OF THE INVENTION

Prior financial transactions are described in Krouse/Meyer in association with FIGS. 1 through 4. By way of summary, traditional bill payment methods have relied on paper invoice cycles, in which payment is remitted by check or money order through the mail, with lengthy delivery and processing delays. In-person payment alternatives have been limited. Although electronic methods have offered improvements, billers still experience high bill processing costs, large numbers of in-person payments, and unacceptable error rates. Consumers remain dissatisfied with available options for in-person payment.

Krouse/Meyer describes a barcoded electronic system for bill payment and other monetary transactions. That system enables efficient financial transactions at retail checkout scanners, as part of the normal retail sales process. Krouse/Meyer addresses the bill payment problem described above. This disclosure improves the Krouse/Meyer solution in two key areas: in the way payments and associated data are managed and tracked throughout their life cycles; and in the way payments initially enter the processing stream at a retail location.

### SUMMARY OF THE INVENTION

As with Krouse/Meyer, this disclosure describes a bill payment system and method that primarily support a cycle of a) billers who provide goods and services, b) consumers who pay for them, c) retailers who accept those payments, and d) processing networks who move payments and information back to the billers. Related cycles are also described, showing how the same system and method can support funds transfers between parties with relationships other than biller-to-consumer, such as consumer-to-consumer and business-to-business. Utilizing a combination of existing technologies, new technologies, and new methods for integrating them, a cohesive process is enabled in which all participants are able to manage payments efficiently.

A key element in Krouse/Meyer is the use of barcoded data to initiate each payment. Payment usually begins through the presentation of the barcode at a retail location, using a conventional retail point-of-sale barcode scanner. Each such barcode contains an algorithmic “Signature” by which the payment and its intended processing method can be identified. Krouse/Meyer presents details on how such “Signatures” are constructed and used, how they facilitate the exchange of information associated with efficient payment processing, and how they can be transmitted, transformed, and presented (through the use of “Invoice Surrogates” and “Mediating Technologies”).

This disclosure describes specific techniques by which payments utilizing barcode “Signatures” can be processed, including ways to manage the data, algorithms, and other rules used such payments. One particular technique (the use of “Payment Tracking Identifiers” in conjunction with a “Payment Tracking Database”) allows consolidation and tracking of payment details, as a transaction moves among independent systems and organizations. The result is a comprehensive processing network capable of managing and tracking a payment and all its pertinent data, from the time the customer's obligation is first created, through the time the funds arrive at the biller, and spanning all the intervening steps of invoicing, presentment, tendering funds, consolidation, funds transfer, etc., and possibly involving many different service providers, and the diverse rules they must each apply in order to recognize and process each payment correctly. This disclosure describes a system analogous to the kind of cradle-to-grave tracking systems used today in other industries, such as package delivery and supply chain management; but instead of tracking packages or other objects that are managed by a single organization, it tracks payments plus associated events and rules that span multiple organizations. The existence of such a payment tracking system could allow a standards body, such as the USPS, to authorize a “Payment Time Stamp” generated by the system—an imprimatur that would be analogous to a USPS postmark as a proof of timely payment.

A broad range of payment media, presentation media, and other methods are consistent with this disclosure, discussed in Krouse/Meyer and examples herein. In overview, most of the embodiments consist of the following general elements: a) they enable a first party to supply a printed barcode (or a surrogate form) to a second party, containing sufficient information to identify the first party (e.g. a network ID or Biller ID plus an account number or other identifier) and utilizing an algorithmic “Signature” to control identification and processing of the barcode; b) they enable the second party to utilize this barcode (or surrogate) to tender payment at a third party location (e.g. a retailer); c) they enable the third party to process the payment, collect an appropriate fee, and send funds to the first party; and d) they enable the first party to access the transferred funds quickly. Most examples herein are enumerated, e.g. Example System A, purely for convenience of reference. No inference should be drawn from the use, choice, sequence, or omission of such labels.

At least one embodiment of the present invention comprises an improved financial transaction device comprising barcoded data incorporating one of a plurality of algorithmic signatures, the signature being configured to permit at least one party involved in a financial transaction to store pertinent data in a multi-organizational payment tracking database. It may further comprise elements capable of referencing some of the pertinent data. It may further comprise a payment tracking identifier capable of uniquely referencing a single financial transaction and some of the pertinent data. It may pertain to the transaction, to the signature, to a party involved in the transaction, to other pertinent data, or to any combination thereof. It may further comprise at least one rule that applies to at least one element of the pertinent data, whereby the rule or a plurality of rules enable a party involved in the transaction to determine an aspect of the format, interpretation, or processing of the transaction or of the pertinent data, or that the rule or rules control the ability of a party involved in the transaction to access or to modify the pertinent data.

At least one embodiment comprises a format signature for device recognition, the signature comprising a substantially unique pictographic Image configured to reflect a substantially unique set of visual features appearing in a two-dimensional arrangement on the device, whereby a scanning system can automatically recognize an instance of the device by electronically comparing the instance with a plurality of said signatures arranged into a pictographic alphabet.

At least one embodiment comprises a data transfer device comprising an open-ended two-dimensional series of alphanumeric characters or other distinct symbols, the series being derived from source data through an automated encoding process based on an encoding signature, whereby a corresponding decoding process installed on an automated device may reliably use the encoding signature to reconstitute the source data through visual processing of the series and visual recognition of the distinct symbols. The device may be read using a scanner and processed using OCR (optical character recognition). It may further comprise a rule or rules that control the automated device, in a form suitable for updating the automated device, where a rule represents at least one element in a library used by the automated device. The element may represent a format signature for device recognition, the signature comprising a substantially unique pictographic image configured to reflect a substantially unique set of visual features appearing in a two-dimensional arrangement on the device, whereby a scanning system can automatically recognize an instance of the device by electronically comparing the instance with a plurality of said signatures arranged into a pictographic alphabet.

### BRIEF DESCRIPTION OF THE DRAWINGS

FIGS. 1 to 3 are exemplary prior art remittance stubs from utility companies.

FIG. 4 is a process flow diagram of an exemplary prior art bill payment system.

FIG. 5A is a process flow diagram of an exemplary bill payment system consistent with Krouse/Meyer, with additional elements consistent with the present disclosure.

FIG. 5B is a table summarizing an exemplary dialogue between a “POS System Host” and a “DCNI,” showing the validation and submittal sequence.

FIG. 5C is an exemplary prior art remittance stub from a utility company, used to create FIG. 5D.

FIG. 5D is an exemplary reduced-resolution blurred glyph pictograph) generated from FIG. 5C.

FIG. 5E is an exemplary portion of a pseudo-font created from glyphs (pictographs) similar to FIG. 5D, for use in OCR recognition of bill formats.

FIGS. 6 and 7 and FIGS. 8A to 8C are illustrations of exemplary data structure of elements underlying the barcode “Signature” in embodiments of Krouse/Meyer.

FIG. 9 is a table illustrating the results of an exemplary split modulus matching calculation in one embodiment of Krouse/Meyer; it has been reformatted here for clarity.

FIGS. 10 to 21 are diagrams and examples from Krouse/Meyer. They are expressly cited in the present application, but are included for convenience.

FIG. 22 is a process flow diagram of another exemplary bill payment system consistent with Krouse/Meyer.

FIGS. 23 to 26 are examples from Krouse/Meyer. They are expressly cited in the present application, but are included for convenience.

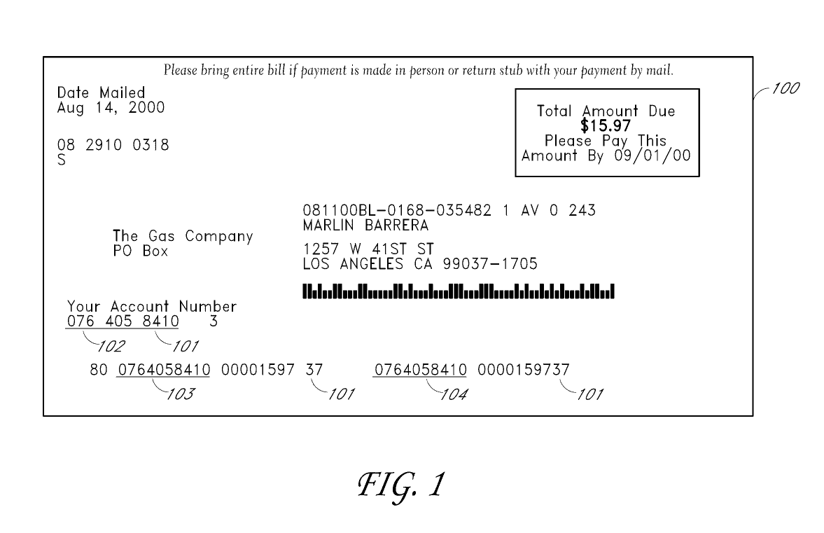

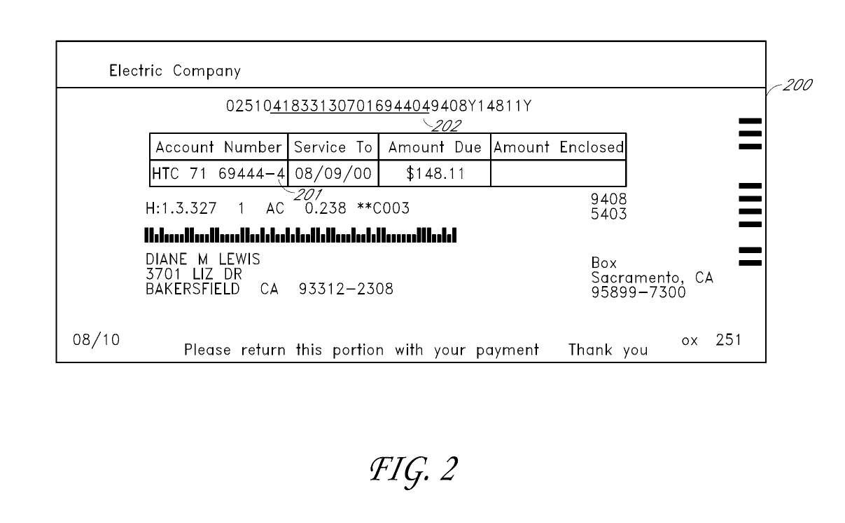

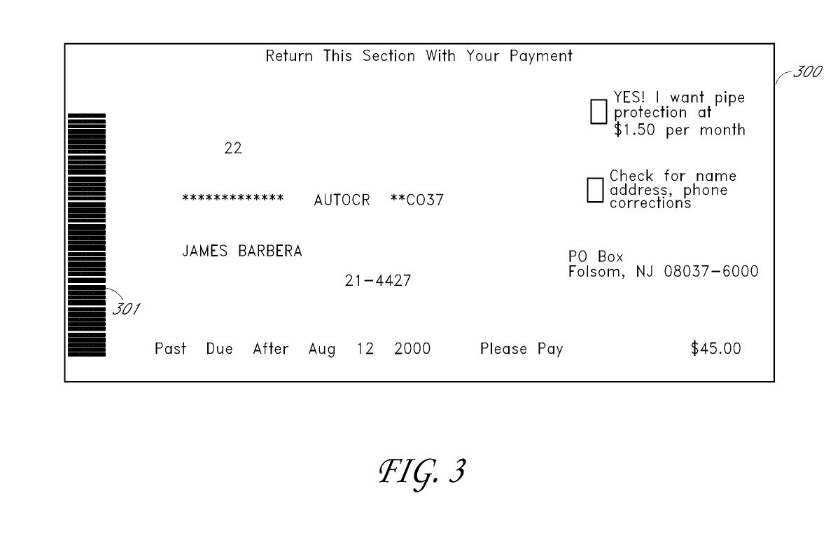

### DETAILED DESCRIPTION OF EMBODIMENTS

Many of the Krouse/Meyer methodologies, as set forth in detail in the Krouse/Meyer patents and applications, establish an electronic network for effecting monetary transactions, for the benefit of a plurality of billers, a plurality of retailers, and a plurality of consumers, through the use of barcoded transactions (or their surrogates) that utilize an algorithmic “signature.” Each of those entities reflects a possible participant in a financial transaction, whether it is the biller issuing a bill for services or goods, a consumer paying the bill, or a retailer to whom the consumer pays money against the bill, all of whom are parties to the transaction. The participants may also include a service provider engaged to process the financial transaction for the benefit of the payor and payee. All these entities may be described as being involved in the transaction.

One object of the inventions disclosed herein comprises facilitating the orderly flow of transactions through a Krouse/Meyer system, via structured mechanisms for encoding, standardizing, exchanging, and managing the processing rules that affect those transactions. Another object includes giving participants in Krouse/Meyer transactions appropriate access to extended information about each transaction, beyond its internal data elements. This includes state information, metadata, and other elements not traditionally incorporated in financial transactions as such, and may include such details as transaction processing history, transaction participants, and applicable processing rules, all of which may be represented in canonical form. Other objects or objectives include:
facilitating evolutionary change and growth over time, with respect to data scope, processing capabilities, rule complexity, data format, range of participants, and other aspects of a particular embodiment of a Krouse/Meyer system. In other words, facilitate implementation and deployment of a family of Krouse/Meyer systems (deployed either together, at one time and place, or changing over time or location), rather than limiting an implementor to fixed details of a particular embodiment;
facilitating incorporation of enhanced capabilities for privacy, security, reliability, and other evolving requirements without the need for wholesale system replacement;
enabling use of a uniform “Payment Tracking Identifier” system, so that billers, retailers, consumers, and other participants in a payment transaction may aggregate and track all data, history, and other pertinent data related to each bill payment being processed, said data being stored in a multi-participant “Payment Tracking Database” or equivalent (comprising data elements that may be acquired before, during, or after the processing of individual payments, including the rules for that processing);
enabling each participating biller to choose, independently, whether to identify and track payments by incorporating either of the following elements in the barcode “Signature”: a) a biller-specified account identifier, such as the biller's existing internal account number; or b) a “Serial Number” payment identifier, as described in this disclosure, said identifier either being assigned independently by the biller, or being automatically generated for the biller by a third party or by an embodiment of this disclosure;
enabling each participating biller to choose, independently, whether to use a barcode “Signature” to supply data for use in payment processing either: a) directly, where the necessary data values are extracted from the barcode without modification; or b) indirectly, where the necessary data values are automatically translated or retrieved from another source, and in particular, from a “Payment Tracking Database” (or from equivalent biller-supplied data records), from which data is retrieved automatically that would otherwise have been stored within the barcode “Signature” (such as a Biller ID or customer account number). Any barcode “Signature” consistent with this disclosure may potentially include either or both kinds of data, at the biller's choice;
allowing any given bill payment (corresponding to a particular barcode “Signature”) to be interpreted and processed in accordance with certain encoding, transmittal, tracking, and other processing rules (collectively: “Payment Processing Rules”) which may be specified or implemented through a variety of mechanisms as described in this disclosure, and which may include elements: a) from within the barcode “Signature” or equivalent; b) from within the non-barcoded parts of an invoice; c) from a “Payment Tracking Database” or equivalent; d) from a biller-supplied database or similar source; e) from a “biller directory” or similar set of biller-specific rules, which mayor may not itself be part of a “Payment Tracking Database”; f) implicit in logic incorporated in a retailer, biller, or other computer system; or g) implicit in logic that is predetermined in a particular embodiment of this disclosure;
allowing any given “payment processing rule” (specified via one of the means identified in this disclosure) to apply to: a) only a single bill payment, corresponding to a particular barcode “Signature”; b) a group or class of bills (such as “all late payments” or “all bills in Arizona”); c) the bills associated with a particular biller or group of billers; d) the bills arising from a particular retailer or group of retailers; e) bills having some element in common (such as an “expedited payment” flag); f) bills identified through some other means; or g) arbitrary subsets of pertinent data managed in a “Payment Tracking Database,” including the rules themselves;
allowing automatic use of a plurality of barcode “Signature” systems, either at the time of payment or during subsequent processing, to determine or modify the applicable set of “Payment Processing Rules” that will govern the processing of that payment;
allowing each participating biller to choose or control, independently, the specific “Payment Processing Rules” that may apply to a particular bill or group of bills, through the mechanisms described in this disclosure;
allowing a given biller's invoice barcode “Signature” to be presented to the retailer through an “Invoice Surrogate” as described in Krouse/Meyer and in this disclosure (i.e. an alternative representation of a biller's invoice, such as a copy printed from a website or received via a fax), suitable for payment processing using an embodiment of this disclosure, and which may be created or processed through the use of a “Mediating Technology” (i.e. some hardware, software, system, or other elements capable of performing translation, bridging, or other operations needed to effect payment or processing), where said “Mediating Technology” applies methods as described herein to transform data from a biller's original invoice or other source data into a barcode “Signature” or equivalent representation, suitable for payment using systems and methods consistent with this disclosure; and allowing the use of “Invoice Surrogates” and “Mediating Technologies” within a Krouse/Meyer system to process out-of-system bills, despite the lack of a barcode “Signature” and despite the associated billers not participating directly in the system. In other words, enable a Krouse/Meyer system to accept, process, submit for payment, tender through existing financial conduits, and otherwise process bills that lack the barcode “Signature” system described in Krouse/Meyer, through the use of techniques described in this disclosure.

### Example Embodiments

The Krouse/Meyer patents and application describe systems and methodologies accompanied by a series of simplified examples, each illustrating different aspects of the present invention and related technical concepts. To aid in presenting embodiments of the present disclosure, consider Examples A through D in U.S. patent application Ser. No. 11/932,048, which are summarized below.

Example System A is a simple payment processing system, which in summary includes: a) a mechanism allowing a biller to generate at least one invoice for at least one customer, where the invoice contains a unique barcode “Signature,” comprising data identifying at least the customer and the biller; and b) a scanning apparatus and associated components, for use by a retailer or other third party, configured both to scan the barcode and, based on the identifying data of the barcode, to effect payment to the biller in a predetermined or customer-specified amount.

Example System B is a network configuration of Example System A, which in summary includes: a) mechanisms allowing a plurality of billers to generate barcoded invoices; b) networked mechanisms allowing a plurality of third parties, in communication with said billers, to scan and effect payment for said invoices; and c) other system elements as described in Example System A.

Example C extends the system and method of Example B to utilize “Invoice Surrogates” in place of the invoices used in Example B. As described in Krouse/Meyer, an “Invoice Surrogate” is an alternative representation of a biller's invoice, suitable for payment processing using Krouse/Meyer. It is thus
“an alternative form of invoice, either received, accessed, or created by the customer, and capable of presentation to the retailer in a form suitable for scanning at the retailer's point of payment. An example of an invoice surrogate is a faxed image containing the same unique bar code format that would otherwise appear on a biller invoice . . . . Before its presentation in bar code format, the invoice surrogate may pass through one or more intermediate forms, e.g. electronic transmission, email attachment . . . , or printing on a transmittal slip.” (p. 11)

Example D extends the system and method of Example C to utilize a “Mediating Technology” to create an “Invoice Surrogate.” As described in Krouse/Meyer, a “Mediating Technology” is some hardware, software, system, or other elements capable of performing necessary bridging or other operations. It thus
“might include such features as automated translation between barcode symbologies, translation of text from a paper or electronic invoice, or database lookup to convert a transaction serial number to an account number. Such mediating technologies would serve to transform data from the biller's original invoice into a bar code or equivalent representation suitable for payment.” (p. 12)

Elements and terminology from the above four Examples A through D will now be used as background for example embodiments of the inventions described herein.

### Improved Bill Payment System Details

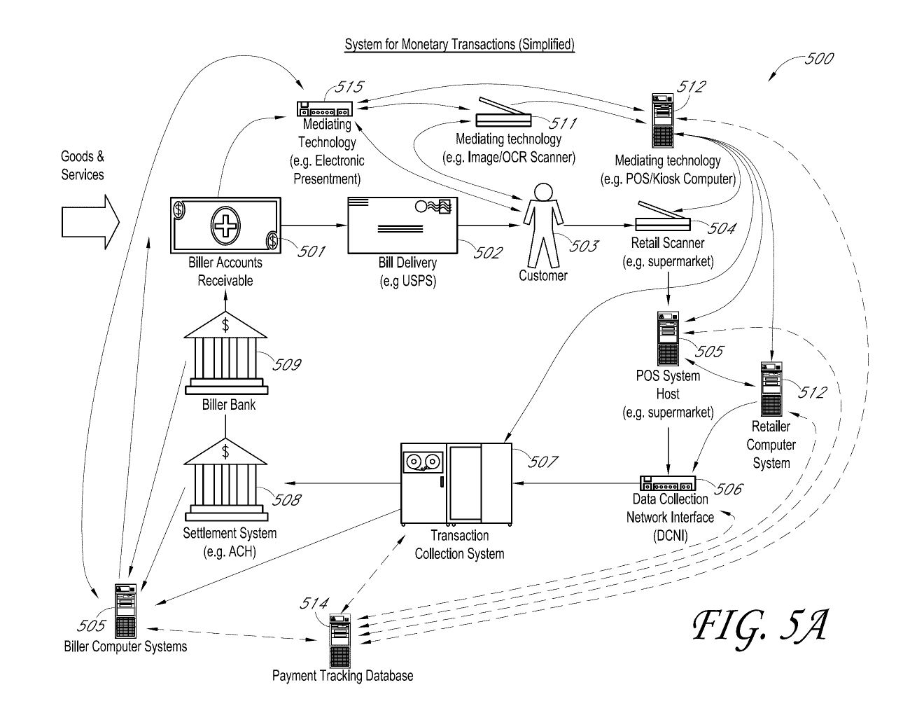

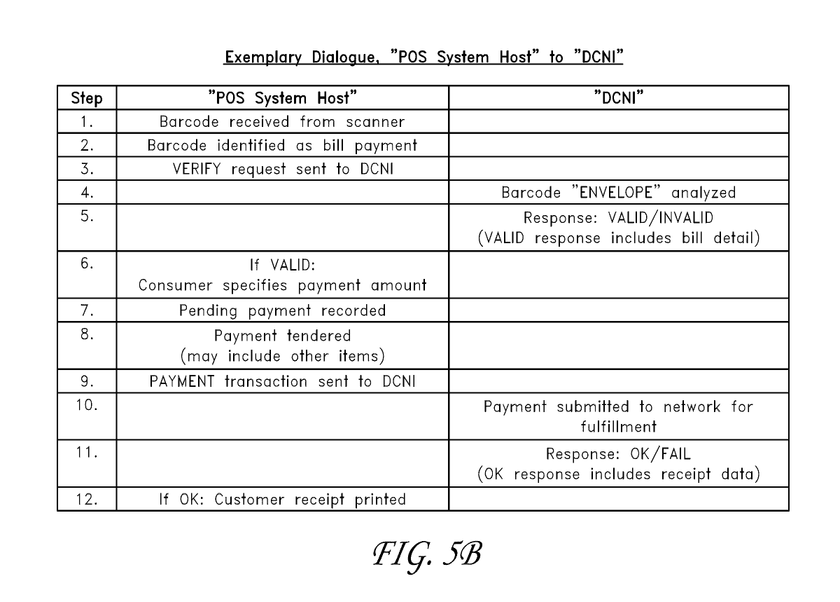

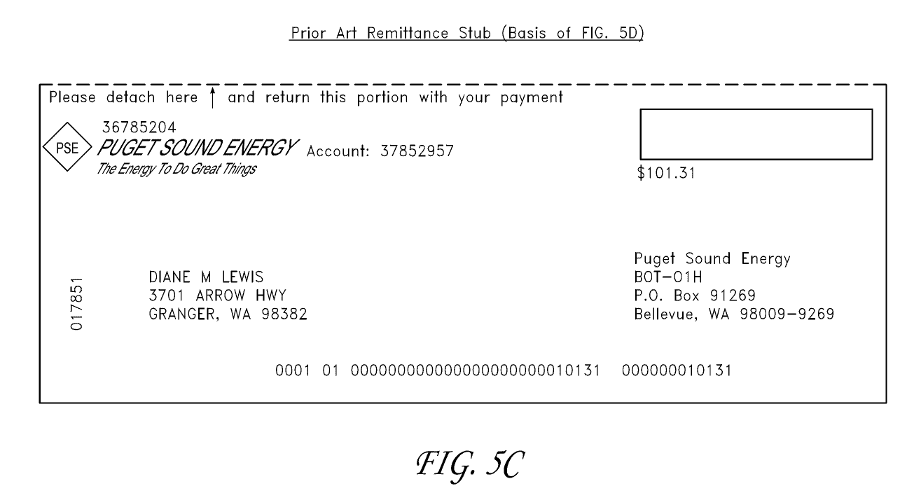

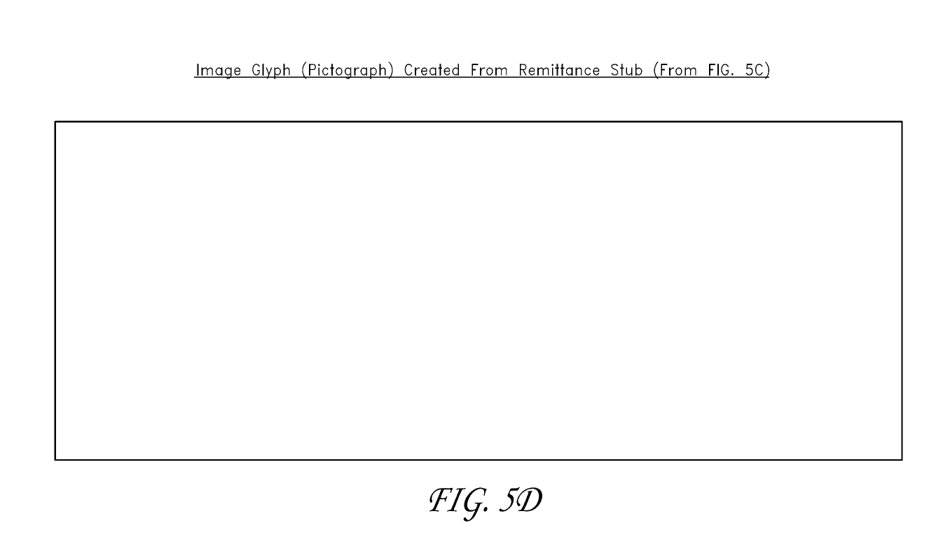

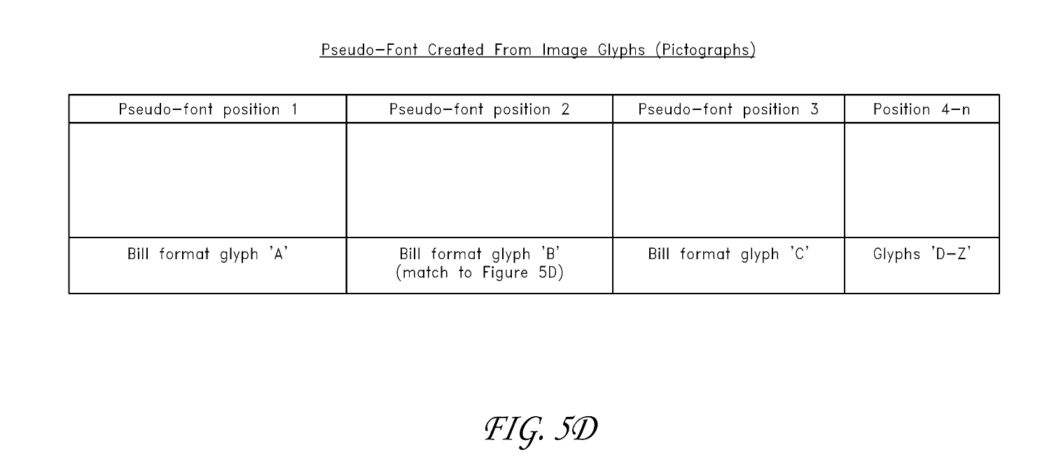

Turning now to the simplified example in FIG. 5A, which we shall refer to as Example System E, a barcoded bill payment based system 500 consistent with Krouse/Meyer and improved by the present disclosure includes: a) a biller invoice, said invoice then being delivered through various means to the customer, as described in Krouse/Meyer and below; and b) payment information and payment credits that are delivered to the biller electronically through various means, as described in Krouse/Meyer and below. System elements enabling these means of delivery are now presented in greater detail. (Some of these steps are summarized from Krouse/Meyer, particularly the inner ring of elements 501 through 509.)

For all the goods and services rendered to a customer over a given billing period, the biller's accounts receivable 501 accumulates a dollar total, and generates a detailed invoice. In the Krouse/Meyer example embodiments, the invoice normally includes a special barcode “Signature”; but in this disclosure, the invoice may omit a barcode, which would be replaced by an “Invoice Surrogate.”

As in Krouse/Meyer, the invoice is delivered to the customer 503. Figure SA illustrates delivery of the invoice via the USPS 502, and also via other means including electronic bill transmittal or presentment 515. Other mechanisms could serve a similar role, and although not illustrated are part of Example System E. At some time after the customer receives the bill, the customer 503 pays the bill, typically by taking the barcoded invoice to a participating retailer (e.g. a supermarket) where bill payments are processed. When using a printed invoice (whether received via mail or printed after electronic delivery), the customer typically presents the stub or other appropriate portion of the barcoded bill remittance to the checkout cashier, for scanning at the retail scanner 504. (Alternative remittance techniques that use a “Mediating Technology” 515, 511, and 512 to create “Invoice Surrogates” are discussed herein, and are also part of Example System E. Regardless of whether a “Mediating Technology” 515, 511, and 512 is employed, bill payment typically proceeds using point of sale components 504 and 505, though as shown data flows to other elements 507 and 513 may be chosen that bypass those elements.

We first consider the case of an invoice with a barcode that is scanned at the point of sale 504. When the bill payment barcode is scanned, the scanner and its associated retail point-of-sale “POS System Host” 505 identify the barcode as a probable bill payment, containing payment details (such as the biller to be paid and an account number to be credited), as opposed to information about a retail UPC item, coupon, gift card, or other traditional retail transaction. The “POS System Host” 505 takes additional steps as appropriate for the payment transaction, such as prompting the cashier or customer to enter a payment amount or to select payment options. If available within the barcode data, the bill's amount due may be displayed at the register as a default value, allowing the cashier or customer to enter the amount desired, or to accept the default if available.

As in Krouse/Meyer, the payment amount plus all other payment details are recorded by the “POS System Host” 505, and saved until the payment transaction is consummated and customer payment has been tendered.

Although FIG. 5A illustrates the “POS System Host” 505 as a monolithic component connected to other retailer computer systems 513, many retailers utilize complex computer infrastructures, consisting of many different computer systems at various locations. For the purposes of this disclosure, such configuration differences are irrelevant. Implementation details may be guided by specific retailer interface requirements.

The “POS System Host” 505 or other retailer system 513 is typically in communication with a data collection network interface 506 (“DCNI”) which in this embodiment assists in the verification and preparation of bill payments. The “POS System Host” 505 and the “DCNI” 506 communicate using the structured dialogue shown in FIG. 5B. As shown in FIG. 5A, the “DCNI” 506 is an intermediary between a retailer system 505 or 513 and the downstream systems 507 to 509, the systems that actually fulfill payment transactions. (As described in Krouse/Meyer, and as well-known in the art, the functional dividing lines between such systems are implementation choices. A given payment function may in fact be handled by the “POS System Host” 505, by the “DCNI” 506, by a chain-wide server in a retail data center 513, or by a third-party fulfillment or other system not shown in the diagram. In Example System E, the “DCNI” 506 has been designed to minimize the need for modifying the “POS System Host” 505. In another embodiment, the “DCNI” 506 could be eliminated, by connecting the “POS System Host” 505 directly to the fulfillment systems, and by adding the “DCNI” 506 functionality to another platform such as a retailer system 505 or 513, to the “Transaction Collection System” 507, or to the “Payment Tracking Database” 514.)

We now resume the description of processing within Example System E (as shown in FIG. 5A), at the point where the customer has tendered payment. As with Krouse/Meyer, any pending bill payments recorded during the current sale by retailer systems 505 or 513 are released for fulfillment processing via the “DCNI” 506 and downstream systems 507 to 509 and 514, in conjunction with normal retail system processing 513 for receipt printing, accounting, funds reconciliation, auditing, store/chain reporting, and other typical requirements. The customer will normally receive a printed or other receipt documenting details of the payment made, indicating such elements as the biller name, date and time of payment, a transaction identifier, and store location. In addition to its familiar role as a retail document, such a receipt is also intended to give the customer a proof of timely payment, and as a design goal should include sufficient data for customer and biller to reconcile any possible payment disputes. Text destined for the receipt might arise from various sources, including the barcode “Signature,” a “biller directory” managed on the downstream systems 507 to 509 or 514, a “Payment Tracking Database” 514, and the various other system components that may participate in the payment transaction.

In Example System E, standard transaction processing techniques (familiar to those skilled in the art) are used to ensure reliable transaction delivery despite the risk of equipment or communications failure. A variety of proven and reliable methods are well known in the industry.

As each bill payment is consummated, retail systems 505 or 513 forward payment data to the “DCNI” 506 for fulfillment processing via the downstream systems 507 to 509 and 514. In Example System E, the “DCNI” 506 operates as a “pass-through node,” i.e. a pending transaction never resides solely on the “DCNI.” Instead, the retailer system 505 or 513 submits a payment transaction to the “DCNI,” and waits until the “DCNI” has successfully passed it forward to a recipient system (e.g. the “Transaction Collection System” 507). This configuration ensures that a hardware or communications failure would never risk the loss of a transaction. In contrast to the “DCNI,” the “Transaction Collection System” 507 or another intermediary node (not shown) is responsible for guaranteed delivery of all accepted transactions, and can therefore utilize appropriate well-known technologies to ensure redundancy and fault tolerance.

With this embodiment choice, i.e. using a “pass-through node,” the retail point-of-sale system waits until each payment transaction is accepted. Consequently, if an error condition were to cause a submittal delay, then the customer might have to wait before a receipt could be printed. In this configuration, transaction submission is a time-critical step. Design goals would be to optimize the process for rapid completion (milliseconds), and for extremely robust and reliable links in the physical and logical connections between the various involved components 505 to 507. Example System E uses this configuration for reasons described below, but other techniques are capable of equally good results. The technical trade-offs will be familiar to those skilled in the art.

In Example System E, a single large “DCNI” platform 506 is shared by most retailers. It is located at a secure data center, e.g. near to the “Transaction Collection System” 507, and is accessed from retailer locations via dedicated data communication circuits or via the Internet. In addition, dedicated large “DCNI” platforms may be installed at the data centers of large retail chains, each serving a subnet consisting (for example) of just the stores in a single chain. These might be co-located with or integrated with other retailer systems 513 or downstream systems 507 or 514. Finally, stand-alone mid-size or small “DCNI” platforms may be installed at other retailer locations. Equipment, connectivity, topology, and other details involve standard technical issues that will be familiar to those skilled in the art. In this embodiment, these “DCNI” platforms all serve as “pass-through nodes,” as described above, and are used to offload verification and submittal services from each retailer's systems 505 and 513 and from downstream systems 507 and 514.

In an alternative embodiment, a different type of “DCNI” 506 is used: a “store and forward “DCNI.” This configuration collects and stores a series of payment transactions locally, before submitting them in batches to a downstream system 507 or 514. A “store and forward “DCNI” could be installed at any of the locations discussed above, i.e. at a secure data center, at a chain headquarters, at a particular retail store, or as a component of another system element. When using this configuration, all payment transactions can be preserved reliably on the “store and forward “DCNI” until they can be submitted downstream for fulfillment. This could be accomplished in various ways. One approach is to save transaction data in non-volatile memory within the “DCN!.” Another approach is to employ redundant fail-over hardware. Yet another approach is to utilize a backup medium, such as CDR, magnetic tape, or even a paper document, from which unsubmitted payments could be automatically or manually reconstructed and resubmitted for payment in the event of system failure.

Regardless of the recovery technique chosen, during normal operation the “store and forward “DCNI” 506 would send periodic batches of payment transactions to the “Transaction Collection System” 507, possibly via an intermediary system 514. Batch timing might be based on time and transaction volume thresholds or other criteria, and would typically include a final transmission immediately before the daily “Transaction Collection System” 507 aggregation time.

With this alternative embodiment, i.e. using a “store and forward node,” the “POS System Host” 505 is not required to wait for transaction acceptance by the “Transaction Collection System” 507. This configuration is thus able to eliminate a key risk of payment processing delays, and the use of a low-latency link between “DCNI” 506 and “Transaction Collection System” 507, at the cost of increased expenditure, complexity, and recovery planning. In Example System E, the simpler “pass-through “DCNI” design is used, thereby creating a design goal that the connection from “DCNI” to “Transaction Collection System” be predictably reliable, fast, and free of latency. (Modem computer and network usage trends support this choice, but it may not be appropriate for certain high-volume retailers.) Either or both configurations may be used in an embodiment of this disclosure.

The choice of DCNI configuration (e.g. a “pass-through node,” where transactions are sent immediately to the “Transaction Collection System” 507, versus a “store-and-forward node,” where transactions are held by the “DCNI” 506) affects the meaning of state data collected about each payment transaction, as aggregated on downstream systems 507 and 514. For example, the way a transaction is added to the payment stream affects how to interpret its recorded submittal time. Thus, although such technical issues are primarily implementation choices that pertain to a given Krouse/Meyer system, they are parameters that affect elements of this disclosure, such as a unique Transaction ID assigned when payment is tendered, or a time-stamp that documents a customer's timely payment, which would normally consider the customer's actual payment time, independent of any subsequent transmittal delays, to help billers assess late fees, etc. These topics are discussed in greater depth in Krouse/Meyer.

Similarly, time synchronization and time reference standards are important design decisions for any embodiment of Krouse/Meyer or of this disclosure. Those skilled in the art will realize that payments may arise from and be sent to multiple time zones, and moreover that the clocks on the various participating computer systems may not be synchronized. In Example System E, a system-wide time standard (based on Universal Time (GMT) or some other time reference), in conjunction with the use of Internet time standards, would ensure that all payments are time stamped relative to a single viewpoint.

Those skilled in the art will recognize that there is a division of function and responsibility among the various components 505 through 507, 513, and 514. Transaction aggregation and delivery can occur on any of these platforms, with corresponding implementation and performance consequences. Regardless of how the various functions are apportioned, these components together enable the same end-to-end behavior, i.e. accepting payment transactions from retailer locations, managing and accumulating related data, and delivering results to billers.

We now resume the description of processing within Example System E (as shown in Figure SA), at the point where a payment transaction has been delivered from the “POS System Host” 505 to the “Transaction Collection System” 507 via the “DCNJ” 506, as described above, using either the “pass-through” or “store-and-forward” approach, and possibly using intermediary systems 513 or 514. The “Transaction Collection System” 507 is then responsible for fulfillment of the customer bill payment, i.e. for delivering the associated funds and information to the biller. It typically does this in conjunction with a “Settlement System” 508 such as the ACH Network. These elements are described in detail in Krouse/Meyer. In summary, various different techniques and resources can be chosen, ranging from a single custom computer system to established commercial services.

The “Transaction Collection System” 507 (along with the other systems it uses, including the “Settlement System” 508) serves seven principal needs, summarized from Krouse/Meyer: 1) provide resources needed by the “DCNJ” 506 to perform verification/validation/submittal; 2) provide reliable aggregation of payment transactions submitted by retailer systems 505 and 513 via “DCNI” 506; 3) support daily retailer information needs, and particularly those related to cash management, such as transaction reconciliation and deposit requirements, including feeds to existing retailer computer systems 513; 4) transmit ongoing payment information to biller computer systems 510; 5) transfer funds between retailers and billers through fulfillment/settlement systems 508 and 509; 6) support biller and retailer personnel when investigating and resolving bill payment problems; and 7) manage access control and security related to all electronic resources. Any of these operations may involve use of or interaction with a “Payment Tracking Database” 514, and generation of payment transactions through mediating technology 511, 512, and 515. These needs create specific technical goals and requirements.

FIG. 5A shows numerous connections linking the “Payment Tracking Database” 514 with “Retailer Computer Systems” 513, “PC System Host” 505, “DCNI” 506, “Mediating Technology” 512, “Transaction Collection System” 507, and “Biller Computer Systems” 510. The “Payment Tracking Database” 514 is a repository of pertinent data and rules related to payments and payment participants, which is potentially updated and accessed at many points in the payment process. It is intended to incorporate such diverse elements as: setup data pertaining to individual billers and retailers; metadata about barcode “Signature” formats and algorithms; life cycle details of individual payments (possibly beginning when the bill is printed and ending when payment is received, and spanning all intervening custody points), and various access and processing rules.

Although the “Payment Tracking Datbase” 514 may superficially resemble a biller's posting file, or a network processor's transaction file, it is much broader in scope, and is intended to serve multi-participant, polymorphic uses. It may thus incorporate distributed responsibility for individual elements, where certain partitions of the data are only visible to or maintained by specific independent entities. For example, a particular biller might maintain its own set of access rules, and update its own subset of payment data fields; whereas a retailer might have access to entirely different aspects of payment data. The superset of all such elements represents the “ground truth” about the many rules and events that pertain to a given payment as it transits the responsible organizations. In the absence of a “Payment Tracking Database,” such information could only be gleaned implicitly from the many independent and often incompatible systems and procedures that are used to process payments.

FIG. 5A also shows several connections linking the customer 503 with the retail scanner 504 and retailer systems 505 and 513, possibly involving “Mediating Technology” 511, 512, or 515. These elements support the creation of “Invoice Surrogates.” FIG. 5A shows the use of electronic presentment 515 or other mediating technologies as a way to supply an “Invoice Surrogate” to initiate the payment transaction. The use of specific OCR technology for this purpose is discussed in more detail under the heading “Invoice Surrogates and Mediating Technology.”

In method form, Example System E includes: a) printing or otherwise delivering invoice data from a biller to a customer; b) presenting said invoice data at a retail location via a barcode incorporating an algorithmic “Signature” (either present on the biller invoice or on an “Invoice Surrogate” or via a “Mediating Technology”); c) delivering payment information and payment credits to the biller electronically; and d) enabling use of a “Payment Tracking Database” to facilitate efficient operations.

It should be stressed that the example embodiments herein (using such elements illustrated in FIG. 5A as an in-store retail scanner 504, and a retail “POS System Host” 505) are provided as examples that are consistent with this disclosure and with Krouse/Meyer, but are not intended to imply limitations or requirements through their choice of components.

### “Transaction Collection System” (Example System E)

The following headings describe how an idealized “Transaction Collection System” based on Krouse/Meyer can be used as a foundation for Example System E. These headings match the list of “Transaction Collection System” needs presented in the preceding section.

### 1. “DCNI” Resources.

In Example System E, the “Transaction Collection System” 507 manages data resources and status values used by the “DCNI” 506 as it performs services for the “POS System Host” 505. These resources are either provided to the “DCNI” dynamically, via a high-speed interface, or are downloaded to the “DCN!” for local access (for cases where a shared database or other exchange medium is not suitable). In addition, the “DCNI” 506 and “Transaction Collection System” 507 are able to access and manage elements of the “Payment Tracking Database” 514, and in particular a “Biller Directory” which is used by the “DCNI” 506 to verify, validate, and prepare transactions, and which in turn contains biller-specific “Payment Processing Rules” and other information such as the following: a) biller data, such as Biller ID, biller name, and customer service telephone number; b) bill data and rules, such as check digit algorithms; c) service data and rules, such as “no checks” or other biller-specific retail requirements; d) receipt data and rules, such as advertising, discounts, offers, or notices that should be used in formatting the retailer's receipt text; or e) routing/format data and rules, such as specific fields to include in the payment transaction.

### 2. Payment Aggregation.

In Example System E, the “Transaction Collection System” 507 accepts transactions from the “DCNI” 506 in real time, ensuring guaranteed delivery and providing positive acknowledgement of receipt within milliseconds, typically along with a unique Transaction TD. Such data elements are recorded and managed using the “Payment Tracking Database” 514. The mechanisms chosen for implementing reliable payment aggregation are irrelevant to this disclosure, but might include such elements as databases, FTP/SFTP transfers, load balancing servers, server virtualization, or fault-tolerant hardware.

### 3. Retailer Information.

In Example System E, the “Transaction Collection System” 507 exchanges data with the “POS System Host” 505, and typically with other retailer systems 513, to report ongoing processing conditions and to facilitate the management and transfer of payment funds. Since each retailer utilizes its own computer systems 513 and associated procedures for auditing, reconciliation, and similar tasks, in conjunction with data derived from the “Payment Tracking Database” 514, a variety of financial tools and mechanisms are appropriate. A key need is for daily marginal reports that summarize store- and chain-wide payment counts and totals. These reports are matched against pending biller funds transfers. Biller transfers are time-critical; since some retailers have a slow reconciliation process that will consistently lag behind biller payment requirements, additional cash management resources may also be provided to allow preliminary biller funds transfers before reconciliation, subject to later correction. Some retailers may also need to transfer their calculated calendar-day payment counts and totals to the “Transaction Collection System” 507, for incorporation in combined balancing reports. In addition, retailers need a way to view status information about ongoing payment flow, pending funds transfers, connectivity, and other aspects o(the retailer's payment processing environment. Much retailer information may be managed and exchanged using the “Payment Tracking Database” 514 as a conduit or repository.

### 4. Biller Information.

In Example System E, the “Transaction Collection System” 507 provides information to biller computer systems 510 regarding submitted payments. Since each biller utilizes its own systems and procedures for accounts receivable, customer service, and related processing, in conjunction with data derived from the “Payment Tracking Database” 514, a variety of information tools and mechanisms are appropriate. Four principal biller information interfaces are provided: a) Continuous or frequent bulk data feeds describing the payment transactions sent to each biller, delivered either via cyclic “push” to a biller system (e.g. every fifteen minutes), or via on-demand “pull” (download) by the biller. b) On-demand retrieval by the biller of data about individual transactions or blocks of transactions, via such interfaces as a website or an application portal. c) Daily summary reports describing all current biller payments and transfers. d) Status information about ongoing payment flow, pending funds transfers, connectivity, and other aspects of the biller's payment processing environment. Much biller information may be managed and exchanged using the “Payment Tracking Database” 514 as a conduit or repository.

### 5. Funds Transfer.

In Example System E, the “Transaction Collection System” 507 assembles daily payment transactions into batches, for processing by a “Settlement System” 508 such as the NACHA Automated Clearing House. Many such systems currently exist, most of which act as consolidators, i.e. service bureaus who combine individual transactions into a smaller number of bulk funds transfers. The basic requirement for transfer processing within this embodiment is that funds are transferred between a retailer and a biller, in a way that individual payments made to retailers can be posted by the biller to the correct customer accounts, possibly in conjunction with data derived from the “Payment Tracking Database” 514. Details of such transfers are irrelevant to this embodiment; funds might transfer directly between a retailer bank account and a biller bank account; or they might pass through an intermediary. Similarly, each individual customer payment might generate a separate funds transfer transaction; or payments might be consolidated, such that only a single transfer occurs between each retailer and biller, regardless of the number of distinct customer transactions involved. Existing and possible “Settlement Systems” 508 vary in such respects, affecting their capacity, complexity, cost, timeliness, reliability, and other factors. Any such system is consistent with this embodiment, provided that it can reliably transfer funds in a way that customer payments can be posted correctly. The “Transaction Collection System” 507 assembles and submits settlement transactions using the record formats, frequencies, and other properties appropriate for the selected “Settlement System” 508, and also incorporates the appropriate reporting, auditing, and other control measures needed to reconcile ongoing funds transfers with their associated retailer payment transactions, retailer cash management reports, biller payment transactions, transaction fee processing, and any other data feeds required to interface with the “Settlement System” 508, retailer systems 505 and 513, and biller computer systems 510. Associated rules, information requirements, and data assets may be managed and exchanged using the “Payment Tracking Database” 514 as a conduit or repository. Reconciliation is a very important step in this process, and can have a major effect on the payment cycle time. The “Payment Tracking Database” 514 is a key resource available for implementing multi-participant reconciliation.

### 6. Problem Resolution.

In Example System E, the “Transaction Collection System” 507 facilitates troubleshooting and problem resolution through a number of diagnostic, monitoring, analysis, and control tools. These include: a) data elements, such as transaction identifiers, batch numbers, and other tracking tools; b) data repositories, such as transaction databases and file snapshots; c) status reports and status monitors, providing information about current system operations; and d) interface portals, allowing appropriate support personnel to retrieve data of interest, and to administer processing details. At its most basic level, the system's problem resolution capability can include the ability to trace any payment transaction from end to end through the system, using only the identification data present either in a printed customer receipt (the source transaction) or a biller payment transaction (the destination transaction). These capabilities may be efficiently created through use of the “Payment Tracking Database” 514, illustrating a key advantage of this design.

### 7. Access Control.

In Example System E, the “Transaction Collection System” 507 incorporates sufficient access control and other protection mechanisms to safeguard the privacy and security of all customers, retailers, billers, and other system participants. In other words, positive security controls ensure that each data or control element is only accessible by its intended audience, using the same types of security levels and measures employed in conventional high-quality commercial data processing systems. This typically involves the use of such technologies as password protection, encapsulation, firewalls, data encryption, secure web pages (HTTPS/SSL), and other measures familiar to those skilled in the art. The most critical elements requiring attention from a security standpoint are those that involve: a) the transfer of funds; and b) the use of private customer data. Regarding privacy, it should be noted that the basic payment transaction does not include a customer name, social security number, credit card number, checking account number, or other data fields that would pose a significant security or privacy risk, except in cases where a biller chooses to place a sensitive customer account number within the barcode. (Such values may be hidden through the use of a “Serial Number” as described in Krouse/Meyer and herein.) The primary focus of access and data security is thus preventing accidental or malicious access beyond unauthorized limits, e.g. a biller downloading a transaction file intended for a different biller, or a retailer accessing a system administration control panel. Such access control issues are well understood in the industry. Access and control information may be flexibly managed and efficiently utilized via the “Payment Tracking Database” 514.

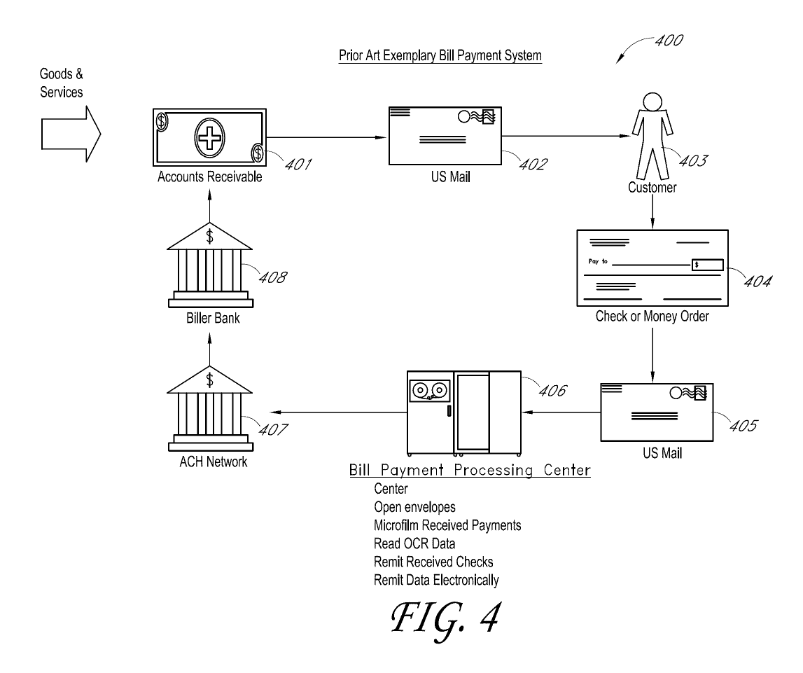

Contrast Example System E, above, with a simplified system that omits or limits the use of “Payment Tracking Database” 514 features and automated information feeds. In one such alternative embodiment (Example System F), a custom-built “Transaction Collection System” 507 receives continuous payment transactions from a co-located “DCNI” 506 device, which is used for the majority of payments, plus zero or more additional “DCNI” devices located at retail facilities. The “Settlement System” 508 used here is the NACHA Automated Clearing House (ACH). Before the last processing window closes at the ACH, all customer payments are sorted and aggregated for direct remission to their respective billers. This operation may take up to an hour. These transactions are then submitted via standard ACH interfaces, which transfer funds to each biller's bank 509 and thereby to each biller's accounts receivable systems 501 and 510 (and thereby to biller customer service and related systems). Note that this part of the system relies on the same basic prior art processes illustrated in FIG. 4, and described earlier.

Note that in this simple Example System F, and unlike Example System E, there is limited or no use of a “Payment Tracking Database” 514, and no separate information feed is provided to move data from the “Transaction Collection System” 507 to biller computer systems 510. Without such an information feed, each biller will only become aware of payments when funds are actually posted to the biller's bank account. A considerable delay might occur between the time a customer makes a payment and the time the biller can respond to that payment. This system thus has two apparent drawbacks: a) it fails to give the customer the benefit of receiving credit quickly; and b) it places the biller in the undesirable position where customer service might be terminated due to non-payment, despite a payment having already been made. For these reasons, Example System E is designed to deliver payment information as quickly as possible, and to utilize a “Payment Tracking Database” to consolidate and distribute such information rapidly and efficiently, subject to biller-specific and other rules.

### Access Security

Example System E addresses the goal, described above, of providing billers with on-demand payment access via a download (“pull”) interface. A large number of biller organizations each need access to a subset of the daily payment transaction flow, a flow that is typically managed by a third party. Associated access rules may be efficiently managed or enforced by using the “Payment Tracking Database” 514 as a conduit or repository.

A variety of well-known data access techniques may be utilized to provide the necessary access control, including database replication, data extraction and transmission (e.g. via FTP), or direct data access via an information portal (e.g. a database query website). These techniques might either utilize or bypass the “Payment Tracking Database” 514. In most cases, standard password protection and encryption keys would be chosen to ensure data security.

For example (Example System G), suppose user ABC at biller XYZ needs to examine payment transactions 1110000-1110099 to research a customer service issue. User ABC might login to a query website, managed either by the organization that administers the collection system or by a third party, which allows users to retrieve data records from a payment database. Alternatively, the database system might automatically create transaction extract files for each user community, and place these files on an FTP server or other password-protected repository. Records might be grouped by time period, locale, or other details. User ABC might then download the appropriate transaction, subset, for analysis using a PC spreadsheet or other tool. Rules controlling access to these transactions, to the associated servers, and to other resources might be managed using the “Payment Tracking Database” 514, or on separate systems. The use of a “Payment Tracking Database” 514 for this purpose allows consolidated management of access rules along with the other elements of payment processing.

### “Invoice Surrogates” and “Mediating Technology”

An “Invoice Surrogate,” with respect to Krouse/Meyer and this disclosure, is an alternative form of invoice, either received, accessed, or created by or for the customer, and capable of presentation to the retailer in a form suitable for use at the retailer's point of payment. An example of an “Invoice Surrogate” is a faxed image containing the same unique barcode “Signature” that would otherwise appear on a biller invoice, i.e. a barcode comprising data identifying at least the customer and the biller (identified directly or indirectly, and suitable for payment as described herein). Before its presentation in barcode format, the “Invoice Surrogate” may pass through one or more intermediate forms, e.g. electronic transmission, email attachment, visual image on a cell phone screen, encoding on an ID card or RFID device, or printing on a transmittal slip.

A “Mediating Technology,” with respect to Krouse/Meyer and this disclosure, is an automated means enabling the creation of an “Invoice Surrogate,” using such methods as: a) translation between barcode symbologies; b) image manipulation; c) OCR translation of text from a paper or electronic invoice; d) database lookup to convert a “Serial Number” to an account number; or e) a variety of other techniques that will be obvious to those skilled in the art.

The following two example embodiments (Examples H/I) describe two such systems and methods utilizing “Invoice Surrogates.” Both these examples share most of their elements with Example System E; thus: a) consumers pay their bills at convenient retail locations; b) consumers receive prompt credit from billers through the payment, settlement, and other mechanisms described above; c) billers receive good payment funds representing the face value of each bill, deposited directly into the biller's bank account; d) billers receive prompt error-free electronic payment data before those funds arrive; e) retailers benefit by facilitating the transaction; and f) related information may be managed and exchanged using a “Payment Tracking Database” as a conduit or repository. However, instead of presenting a preprinted invoice, received from the biller via the USPS, the .customer initiates payment at the retail location by using an “Invoice Surrogate,” either transmitted electronically to the consumer, e.g., by fax, email, or Internet, or produced via a “Mediating Technology.”

Both systems (Example Systems H/I) are consistent with this disclosure, and include: a) mechanisms allowing a plurality of billers to send invoices to at least one customer; b) mechanisms allowing a customer or a third party to access, create, or use an “Invoice Surrogate” for use in payment; and c) mechanisms allowing a plurality of third parties who are in communication with the billers to use an “Invoice Surrogate's” data to effect payment for said customer to said biller in a predetermined or customer-specified amount. In method form (Example Methods H/I), both examples include: a) generating invoices for a plurality of billers; b) accessing, creating, or using an “Invoice Surrogate” to effect a presentation of invoice data for payment; and c) enabling a plurality of third parties in communication with said billers to scan or otherwise process the data from an “Invoice Surrogate,” and use that data to effect payment to said biller in a predetermined or customer-specified amount.

In the first example embodiment of a system using an “Invoice Surrogate” (Example System H), the system described above (Example System HIT) is used by the biller to present barcoded invoices to customers via electronic or other means, rather than via traditional paper invoices. Such media are then used by the customer as “Invoice Surrogates” at the point of payment. In method form (Example Method H), the method described above (Example Method H/I) is followed, but with the customer presenting a barcoded “Invoice Surrogate” to the retailer at the point of payment.

In the second example embodiment of a system using an “Invoice Surrogate” (Example System I), the system described above (Example System H/I) is used to submit payments to billers who do not include suitable barcodes in their invoices. The customer instead utilizes a “Mediating Technology” to create an “Invoice Surrogate,” for use at the point of payment. In method form (Example Method H), the method described above (Example Method H/I) is followed, but with the customer creating a barcoded “Invoice Surrogate” using “Mediating Technology,” and presenting that “Invoice Surrogate” to the retailer at the point of payment.

The following example embodiment (Example System J) provides a more detailed illustration of the use of “Invoice Surrogates,” via a system that is consistent with this disclosure, but one that primarily utilizes conventional technology and methods consistent with Krouse/Meyer. It is derived from the system of Example System I, described above, and utilizes a “Mediating Technology” in the form of a device comprising a computer, scanner, and other components capable of capturing and processing a bill image. The device may be installed at a retail location, e.g. in a kiosk or service desk, or at some other convenient location. By using this device as follows, the customer is enabled to make a payment using a bill that has not been pre-printed with a barcode “Signature”: a) The customer submits the non-barcoded bill to the device for scanning and analysis. b) The device employs conventional technology such as imaging software, OCR (optical character recognition) software, a touch-screen interface, and other elements to identify the biller and extract the necessary payment data, such as account number and payment due. c) If the bill is scanned and recognized successfully, the device then prints a transmittal slip, containing a suitable barcoded “Signature” consistent with this disclosure. d) The consumer brings this transmittal slip to a retail checkout lane, and uses it as an “Invoice Surrogate” to effect payment, just as if this transmittal slip had been provided by the biller with the original invoice. In method form (Example Method J), a method comprising all the elements of Example Method I is modified such that a device comprising a computer, scanner, and other components (capable of capturing and processing a bill image) are used to generate a barcoded “Invoice Surrogate,” which is then used by the customer to pay the bill at a retail checkout lane.

Example System J above has illustrated a basic “Mediating Technology” solution that is based primarily on prior art techniques. Existing OCR technology is widely and successfully used in the art for bill processing, and its use as described above would be an appropriate choice for use in manually-assisted barcoded bill payment. Typically, bill identification relies on a manual selection step, where a human is involved in selecting the correct biller from a list. Various error checking steps are then used to ensure that the scanned bill conforms to the expected format. Accuracy, ease of use, and commercial viability of such a system would be a function of such factors as equipment choice, the physical environment, component ruggedness (particularly of the scanner hardware), whether scanning would be done by retailer personnel or by customers, and the level of tolerance for human interaction during the payment process.

In some circumstances, such with as unattended or high-speed customer use, a more sophisticated “Mediating Technology” may be appropriate to reduce the risk of operator confusion, scanning error, or delay. A progressive series of automatic recognition tests might be utilized for this purpose, with the goal of eliminating manual actions from bill identification. The following example embodiment (Example System K) illustrates how automatic recognition can provide a “Mediating Technology” capable of reducing user interaction while offering more accurate results. The system of Example System J, described above, is modified through the use of the following progressive recognition elements:

1) Example System K may use a “Bill Format Library Database” to assemble and distribute scanning and format details for controlling the device. This library database could be implemented as part of a “Payment Tracking Database” based on biller-specific data and rules, and would contain a series of recognized bill formats, each of which would in turn be associated with a series of recognition signatures and processing rules, such as OCR zones, fonts, “Magic Number” recognition strings, and check digit algorithms. Bills would only to be accepted for “Invoice Surrogate” creation and subsequent payment if they completely matched all the criteria for a particular entry in the bill format library database, and moreover did not match any other entries. A large sample of source bills could be used to assemble the format library database, through a combination of automated and manual administrative techniques. This administration process, along with a regression testing regime, could be used to ensure that all format signatures were mutually-exclusive. When this process detects two very similar bill formats, administrators would use heuristic methods to identify those features that reliably distinguish the ambiguous bill formats. All these rules and other elements could be managed using a “Payment Tracking Database.”

2) Example System K may utilize automated bill type recognition, eliminating the need for a customer or cashier to identify a particular type of bill (e.g. by selecting a biller name from a list). Progressive automated recognition techniques may be utilized, including: a) Creation of a high-resolution, deskewed, despeckled image for OCR purposes. b) Creation of one or more reduced-resolution or blurred images at suitable granularities for format recognition, e.g. 256×64, 128×32, or 64×16 pixels. c) Analysis of these reduced-resolution images versus formats defined in the bill format library database. d) High-resolution OCR processing of data encoded using OCR and MICR fonts, using OCR zones and font optimizations based on bill format library database entries. e) High-resolution OCR processing of data encoded using other (“human readable”) fonts, from which duplicate data (e.g. amount due or account number) or signature values (e.g. zip codes) may be extracted. f) Analysis of high-resolution OCR results versus format signatures in the bill format library database, searching for “Magic Number” values within text to be used for bill format classification (such as known biller zip codes, post office boxes, company names, telephone numbers, or mailing addresses). g) Testing of known check digit algorithms. A variety of well-known OCR and imaging technologies are in wide use in the art, implemented in many proprietary and open-source tools that utilize such methods as feature extraction, projection histogram, image recognition, template matching, boundary-based image invariants (e.g. chain code or Fourier descriptors), or region-based image invariants (e.g. Zernlike moments or Hu's seven-moment invariants), to name a few. When implementing a “Mediating Technology” consistent with this disclosure, one skilled in the art would select an appropriate set of up-to-date OCR and imaging tools.

Note in particular step (c) above, in which OCR technology is used in a novel way to classify each low-resolution bill format. Prior art document processing techniques often rely on a document format database that may appear superficially similar to the format database described above, and that may contain such details as scan regions, font names, and check digit algorithms. However, such format databases have generally only been used after a user has explicitly selected one entry among the various available formats. Only that selected format is tested. In this embodiment, these steps are automated. Many database entries are simultaneously used to process and also test the document, with the goal of selecting one and only one perfect match. (Note that it would be impractical to use a prior art document format database for this purpose, because testing a document against every defined format would require excessive processing time, and because the formats are not designed and managed for this type of unique selection step. In such an environment, automatic format classification might be used to select a “best match”; but to date, these systems have relied on special-purpose, limited algorithms, such as locating straight lines and bounding rectangles within the document image.) This embodiment instead uses a sophisticated classification technique—by turning to recognition mechanisms that have already proven through OCR technology, and applying them in a new way. This approach is described in more detail below.

FIG. 5C illustrates a typical bill format that might be presented as input to a “Mediating Technology” for creation of an “Invoice Surrogate” to use in payment. FIG. 5D illustrates a reduced-resolution bill format glyph, derived from this image by resizing and blurring; this example was created at 256×64 pixel resolution. Note that a glyph of this type, derived from a bill scan, has visual characteristics that a human might associate with an ideograph or pictograph character, such as those used in some Asian languages. This property of a reduced-resolution bill image can be used to aid bill classification as follows: a) A series of such “bill glyphs” (pictographs) may be treated as “pseudo-characters” and assembled into a “pseudo-font,” consisting of reduced-resolution bill format images instead of letters. b) Each pseudo-character in the pseudo-font would correspond to a particular bill format, i.e. an entry in a “Bill Format Library Database” managed within a “Payment Tracking Database.” (A partial example is shown in FIG. 5E, which includes three bill format glyphs labeled A, B, and C.) c) A scanned bill image may then be compared against such a pseudo-font, using conventional OCR techniques. (In the case of FIGS. 5C and 5D, the OCR process would quickly recognize that the image of FIG. 5D most closely matches glyph B.)

OCR techniques are particularly useful for this type of analysis, since OCR intentionally overlooks small variations in format, such as would exist between reduced-resolution bill scans due to differences in names, addresses, etc. that are present on individual bills. At small resolutions, such differences might correspond to just one or two pixels. This approach thus offers very rapid and accurate classification of bills into associated bill types, or categories of bill types. It makes it possible to leverage the significant technical progress that has been made in OCR technology, by applying it to a totally different purpose besides recognizing the individual words and letters within a document. (This approach has wider potential application than for bill payment; any type of standardized document could be recognized in this way.) Once a superficial format match has been achieved, more in-depth verification tests can be applied in sequence, as described above

When deploying an embodiment of this disclosure for production use, empirical testing should be used to determine the accuracy of the classification and recognition techniques chosen. Such factors as operating environment, user population, format library size, and physical document characteristics will influence the number and sophistication of recognition tests required for highly-accurate results. For example, in a system that processes only three standard bill formats with dissimilar layouts, it would be possible to achieve good results using relatively simple classification techniques. A system with hundreds or thousands of similar formats would need far greater attention to detail, particularly during administrative review and preparation of new format database entries.

For ongoing use in a real-life environment, Example System K would also need the ability to add new entries to the “Bill Format Library Database” on a regular basis, as necessary to reflect changes in bill formats and the addition of new billers. A local copy of this data would typically be required at the location where format recognition processing is done. Such updates may be applied through electronic or other automated means. (Update via field maintenance personnel would be avoided, due to its prohibitive expense.) Devices with network connections may be updated using conventional secure file transfers from a central “Payment Tracking Database” or other repository. Devices without such a network connection may be updated by sending revisions to the retailer on a regular cycle, either in the form of electronic media (e.g. a CDR disc), to be loaded in the conventional way, or via a paper document, which may be used to perform an update via the scanner interface. With this novel update approach, a paper update in a special format is transmitted to the retailer (e.g. via email, fax, surface mail, or printed from a website). The retailer then scans this document into the device. The device automatically detects the special format, and loads the contents of such an update document (subject to the entry of one or more encryption keys or passwords, used to secure the device and the loaded content; standard password security prevents a third party from using this mechanism to modify the device maliciously). The “special format” of the update document consists of a series of characters suitable for scanning via OCR, which are assembled into an encrypted message according to an encoding signature that can be decoded automatically by the device, validated, and applied as an update. Standard use of error detection mechanisms such as CRC (cyclic redundancy check) could ensure accuracy. This novel paper-based update mechanism ensures the safe distribution and loading of revisions, without the need for network connectivity or for the transfer of physical media. Such an update message could be transferred electronically and then printed.

3) We now resume the series of progressive verification to enable payment under Example System K. As a final step, before printing the barcoded “Invoice Surrogate,” the device may ask the customer to confirm the basic data to be used in the payment, as retrieved, classified, and interpreted via the scanning/OCR interface. Elements would include such details as biller name, account number or “Serial Number,” amount due, and any other useful data that could be reliably extracted from the document. Such data may be stored in an audit trail on the device, for the purpose of later customer support activities, and might also require that the customer supply or confirm a telephone number or other identifying details. (In another embodiment, the customer may be asked to complete an electronic registration form for access to this capability on a service basis, either in conjunction with a retailer's preference card service or as a separate free or for-fee service. Such a mechanism may be helpful with respect to local compliance requirements or problem resolution measures. It could also enable: a) inclusion of customer identification details on the transmittal slip; b) use of past payment history when classifying bills, customer-specific advertising or offers; c) various other uses that might not be possible or practical in an anonymous checkout lane transaction.) Customers can be informed at this time of their responsibility to verify payment details, and possibly to acknowledge an agreement accepting that responsibility.

4) After adequate measures are taken to insure that information has been accurately extracted from the bill, Example System K could then print a barcoded “Invoice Surrogate,” which in turn could be used to tender payment via a normal checkout lane scanner. Alternatively, the “Mediating Technology” component of Example System K might articulate directly with the “POS System Host” or other retailer system, and bypass the scanning step by submitting a transaction that uses the same barcoded data format, or is otherwise consistent with the result of having scanned a barcoded invoice containing a barcoded “Signature” consistent with Krouse/Meyer.

In method form (Example Method K), a method comprising all the elements of Example Method J is modified through the use of the progressive verification techniques described above, such that a bill is first scanned and classified automatically with a high degree of confidence, and then used to generate an “Invoice Surrogate” in the form of a printed barcode transmittal slip.

It will be obvious to those skilled in the art that Example Systems J and K both utilize widely-used technologies such as image processing and OCR (many of which are implemented in robust form within Open Source Software, and are potentially available at no cost). The present disclosure applies, among other things, to the use of these or other technologies to create a barcoded “Invoice Surrogate” or equivalent, and to the use of certain progressive automatic classification techniques to achieve a high degree of confidence that a given bill has been correctly classified and scanned. “Serial Numbers” and “Payment Tracking Identifiers”

The use of a “Serial Number” field in place of a biller account number can improve privacy and security, by hiding certain data values from those who only have access to the barcode “Signature” data. For such a “Serial Number” to be of use in effecting payment, a corresponding mechanism is also required by which any necessary hidden fields can be recovered at the time they are needed for processing. Techniques for accomplishing this are illustrated in the following examples. The primary mechanism for managing and distributing these elements are described below under the heading “Payment Tracking Database.”

The following example embodiments (Examples L through N) illustrate systems and methods that utilize “Serial Numbers” within barcode “Signature” data. In each case, Example System E is modified to use “Serial Numbers” to enhance processing. These examples illustrate that the use of account numbers per se is not a requirement of the present disclosure, i.e. that use of “Serial Numbers” instead of account numbers is consistent with this disclosure.

In the first example embodiment utilizing “Serial Numbers” (Example System L), a system comprising all the elements Example System E is modified such that a biller assigns “Serial Numbers” for each bill, and encodes these numbers within each bill's associated barcode “Signature,” where they take the place of the biller's normal customer account number. As the payment is processed by this system, and funds are submitted to the biller for the benefit of a customer, that payment is consistently identified using this same “Serial Number,” rather than an account number, which itself is only known to the biller and the customer. After the biller receives funds and payment data, the biller's internal data processing can perform a reverse translation between “Serial Number” and account number, using algorithms and data that are known only to the biller. In method form (Example Method L), a method comprising all the elements of Example System E is modified such that all processing uses a biller-assigned “Serial Number” instead of a biller account number.

In the second example embodiment utilizing “Serial Numbers” (Example System M), a system comprising all the elements of Example System L is further modified such that the payment system itself generates a “Serial Number” for each bill, rather than having the biller assign this number arbitrarily. Example System M generates these “Serial Numbers” and provides them to the biller through one of many possible mechanisms capable of creating an equivalence between “Serial Numbers” and biller account numbers. Examples of mapping mechanisms suitable for this purpose include: a) a lookup table supplied to the biller that maps from “Serial Numbers” to account numbers and vice versa; b) an algorithm or software program supplied to the biller that maps from “Serial Numbers” to account numbers and vice versa; c) an automated service, accessed by the biller via the Internet or via other means, that maps between “Serial Numbers” and account numbers and vice versa, and that can be invoked dynamically as each barcoded invoice is printed and as each payment transaction is processed, or at other convenient times; or d) a “Payment Tracking Database” which manages “Serial Number” mappings along with other payment- and biller-specific details.

Regardless of the technique used to assign and distribute these “Serial Numbers,” the mapping between “Serial Numbers” and account numbers is known within Example System M, and may therefore be used within the payment system for certain aspects of processing that could otherwise only be performed by the biller. In particular, this translation between “Serial Number” and account number can occur implicitly, before payment transactions are submitted to the settlement network (for funds transfer) and returned to the biller (as payment information). This technique would allow a biller's existing data processing systems to accept payments without modification, notwithstanding the use of “Serial Numbers” within barcode “Signatures” to enhance privacy. It would also allow barcoded payment processing based on a reduced number of digits. (In other words, billers using this system need not be aware that a “Serial Number” is printed within the barcode, instead of an account number.)

Alternatively, the mapping between account number and “Serial Number” may be explicitly exposed to biller data processing systems, allowing straightforward biller access of payments by the use of either “Serial Number” or account number.

In method form (Example Method M), a method comprising all the elements of Example Method L is modified such that “Serial Numbers” are generated by the payment system, for each payment, with said “Serial Numbers” then being used instead of a biller account number within the barcode “Signature,” and optionally being used in other aspects of payment processing.

In the third example embodiment utilizing “Serial Numbers” (Example System N), a system comprising all the elements of Example System M is further modified such that a biller is assigned a block of “Serial Numbers,” which can then be assigned arbitrarily by the biller. Each such “Serial Number” can thereby be unique throughout the system, and can also uniquely identify a particular biller; and yet the meaning of each such “Serial Number” could remain private to the biller organization (as with Example System L). The techniques of Example Systems M and N could coexist in the same implementation, allowing some billers to assign their own “Serial Numbers,” while others could use system-generated numbers (or even remain oblivious to their use). In method form (Example Method N), a method comprising all the elements of Example Method M is modified such that “Serial Numbers” are assigned to billers in blocks, which some billers may assign to individual accounts as they see fit.

In the fourth example embodiment utilizing “Serial Numbers”(Example System 0), a system comprising all the elements of Example System M is further modified such that individual “Serial Numbers” do not represent specific biller account numbers, but instead represent other processing elements such as statement cycles or individual payment transactions. Such “Serial Numbers” might either appear in the barcoded “Signatures” placed on printed bill statements or “Invoice Surrogates,” or they might appear in the electronic transactions that are generated from those “Signatures.” Examples of such “Serial Numbers” include: a) a statement identifier (i.e. representing the combination of a biller account number plus a statement date); b) a statement payment identifier (i.e. representing the combination of a statement identifier plus an increment, such that if more than one payment is made using the same statement, successive transactions would have distinct “Serial Numbers”); c) a system-wide payment identifier (i.e. a value that is unique to a given payment transaction within the entire system, and is assigned at the time the transaction is submitted). Like the “Serial Numbers” in Example System M, each such identifier may be used to manage and track payment processing, e.g. within a “Payment Tracking Database,” so long as a mechanism exists by which the identifier can be. used to retrieve the associated payment details. In method form (Example Method 0), a method comprising all the elements of Example Method M is modified such that unique “Serial Numbers” are assigned to payments, based on some process or algorithm by which billers and other parties to the transaction may retrieve account or other data as required to process the transaction.

### “Payment Tracking Database”

Instead of relying solely on data contained within the barcode “Signature” to control processing, Example System E incorporates a multi-participant “Payment Tracking Database” for assembling and coordinating pertinent data related to each payment and its processing. This approach is suitable for the mechanisms described above under the heading “Serial Numbers and Payment Tracking Identifiers.” Note that a “Payment Tracking Database” as conceived herein differs from a traditional payment database as might be implemented within a particular biller, retailer, transmitter, or other organization for its own internal use. A “Payment Tracking Database” manages associated data and events throughout the life cycle of a payment, a life cycle that would typically involve transitioning through multiple responsible organizations. The purpose of the “Payment Tracking Database” is to enable a canonical representation of payment data and events, independent of any single organization.

In an example embodiment utilizing this technique (Example System P), a unique “Payment Tracking Identifier” is used to identify each payment that is tracked by the system. These identifiers are thus payment “Serial Numbers” (as described above), which are assigned and managed using the systems and methods described above. Each payment in the system is thereby associated with one or more database entries, which may contain account data, options, transaction history, and other details that are either useful for or descriptive of the payment process. This “Payment Tracking Database” may be used at various points in the payment process, and may also be made available to independent interested parties including the biller, the retailer, financial networks, or the consumer. By creating a consolidated repository for payment data, this database allows for simplification of individual payment transactions, while expanding the scope of their associated options and details. For example, a “Payment Tracking Identifier” might be used to retrieve such data as Biller ID, biller name, biller customer service telephone number, and payment due date. It could also permit the exchange of extra-transactional data, such as auditing records, performance management aids, customer discounts, special offers, advertising, or changes in customer account status that occur after a statement has been printed. More important for system implementation and evolution, the database could also manage the set of rules and metadata that apply to these payments and their processing. Such rules might be biller-specific, retailer-specific, customer-specific, geography-specific, action-specific, time-specific, or involve other spheres of reference. An important use of this capability could be in compliance, auditing, and other reporting requirements, since certain transactions may require supporting data that might not be convenient or practical to incorporate in either the barcode “Signature” or the lowest-level payment transactions. A “Payment Tracking Database,” indexed by “Payment Tracking Identifier,” enables the use of very compact barcode “Signatures” while allowing a wide array of payment services and options. Techniques for implementing such a database are illustrated in the following examples.

The following example embodiments (Examples Q and R) illustrate systems and methods that utilize a “Payment Tracking Database” to enhance payment processing, e.g. to reduce the size of the barcode “Signature,” to expand the scope of payment processing data, or to allow variation in processing behavior based on various factors as described above. In each case, the system and method described above under Example M are modified to use “Payment Tracking Identifiers” to enhance processing. The use of “Serial Numbers” as record identifiers is a technique already used in data processing. However, these example embodiments go further, and may use “Serial Numbers” as “Payment Tracking Identifiers” to provide common access to payment data for the many independent parties and stages in a payment transaction. In this sense they create an inter-system coordination mechanism.

In the first example embodiment utilizing a “Payment Tracking Database” (Example System Q), a system comprising all the elements of Example System M is modified by removing additional data from the barcode “Signature,” such as the Biller ID or payment amount, and instead automatically storing such data in a “Payment Tracking Database” for subsequent retrieval during payment processing. The resulting barcode “Signature” might only contain a “Serial Number” (i.e. a “Payment Tracking Identifier”) with no additional fields. All other necessary payment data would instead be managed within Example System Q. The “Payment Tracking Database” might be implemented using a variety of existing technologies, and might range in scope from a single physical database managed on a single server, to a virtual database spanning many computer systems and many data and access domains. Regardless of implementation details, Example System Q is capable of translating from a unique “Payment Tracking Identifier” to a set of data elements and rules related to the payment and its processing, elements that can be retrieved, stored, or updated as required to suit the payment process. In effect, the contents of the “Payment Tracking Database” represent additional fields within a “virtual payment record” that consists of all details known to the system about the payment and its participants. Instead of passing all these details in full as part of each payment transaction, they reside in the “Payment Tracking Database.” In Example System Q, the database contains only the most fundamental data elements needed to effect payment, such as: the Biller ID, an account number or “Serial Number” having meaning to the biller, and details of an actual payment such as a time stamp, location, and payment amount, as required to establish proof of payment. Regardless of the specific data fields being managed, their availability during payment processing via the “Payment Tracking Database” allows a greater range of options and functionality than would be possible if every aspect of the transaction had to be encoded within the barcode “Signature.” In method form (Example Method Q), a method comprising all the elements of Example Method M is modified such that “Serial Numbers” are used as “Payment Tracking Identifiers” to access key payment-related data in a “Payment Tracking Database,” data that can thereby be excluded from the barcode “Signature.”

In the second such example embodiment utilizing a “Payment Tracking Database” (Example System R), a system comprising all the elements of Example System Q is modified by extending the contents of each virtual payment record in the “Payment Tracking Database,” to include ancillary data and rules related to payment processing other than what is strictly required to effect payment. Such ancillary data and rules can be grouped in at least three categories: a) additional elements supplied by the biller to augment or control payment processing, such as account status, payment due date, payment expiration date, receipt text, payment restrictions, customer-specific discounts or special offers, and biller-specific processing rules; b) additional elements supplied by the retailer to augment or control payment processing, such as a request for expedited service or payment restrictions, and retailer-specific processing rules; c) payment tracking elements supplied by the retailer or a by payment processing network, such as timestamps, batch identifiers, auditing flags, routing numbers, and processing-related rules. It will be obvious to those skilled in the art that the “Payment Tracking Database” might contain a wide range of data elements, deriving from any of the data objects, events, or participants in the processing flow. These might span the printing of the bill, submission of the bill for payment, tendering of payment, submitting the transaction, printing the receipt, transferring of funds between companies, or managing any other aspects of processing. Moreover, such data may also be used to capture events outside the actual payment process, such as customer status changes after the bill is printed. Regardless of implementation details, Example System R is capable of preserving and managing a payment transaction's details and ongoing processing state, a state that will change over time. By the time a payment reaches the biller's bank account, the system is capable of assembling a rich history of processing details, based on a rich tableau of rules, instead of simply recording payment amount, date, and account number. In method form (Example Method R), a method comprising all the elements of Example Method Q is modified such that “Serial Numbers” are used as “Payment Tracking Identifiers” to access comprehensive payment-related data and rules, including data excluded from the barcode “Signature” as well as a variety of processing details and options.

It will be apparent to those skilled in the art that the use of a “Payment Tracking Database” intrinsically involves the creation of a shared layer of processing, transmission, and data overhead. In order for such data to be of use, it must be assembled, managed, and accessed, all of which will tend to add to the already substantial transaction burden of high-volume payment processing. Given today's computer resources, performance trade-offs may be involved. However, three factors should be weighed when considering implementation scope: 1) The industry trend is for faster processors, faster networks, and increasing capacity. These all work in the favor of increased scope and generality of data and rules. What was too expensive in 1990 is justified in 2010 and may be trivial in 2030. 2) This approach creates the opportunity for expanded services and enhanced privacy, with possible direct financial benefits that could offset the added costs. 3) Similar objections could have been raised when contemplating analogous data management needs for airline reservation systems, package tracking systems, and help desk systems. Although payment transactions may exist in daunting volumes, they share the same need for integrated data management over time. Defining and Managing Barcode “Signatures”

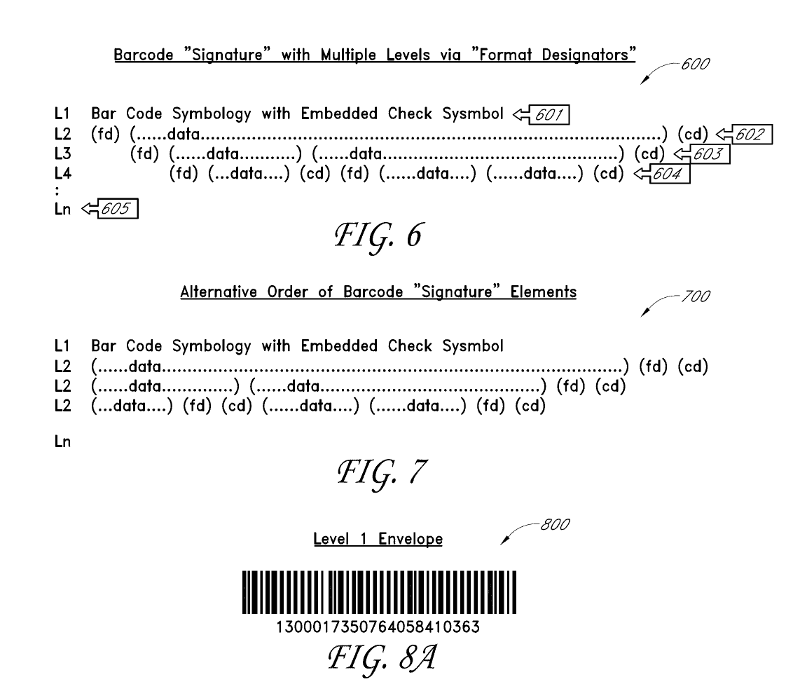

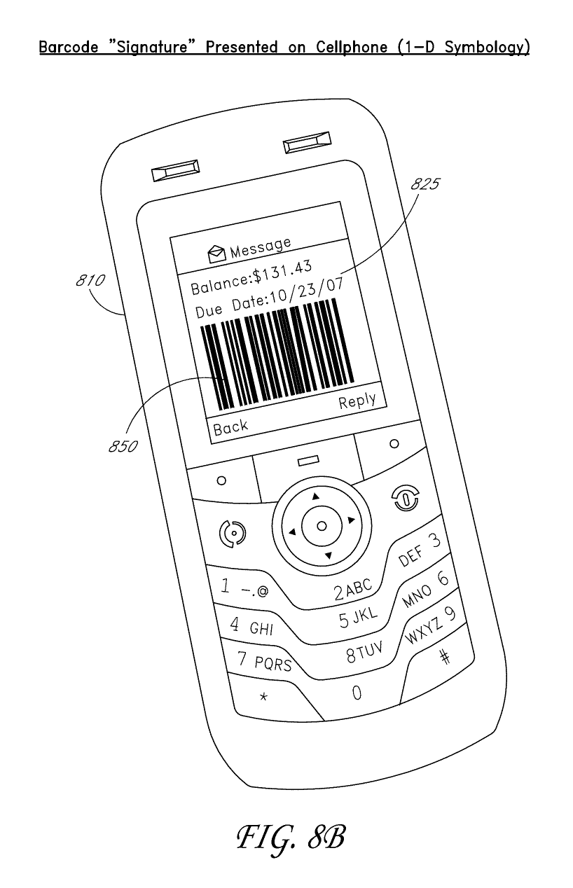

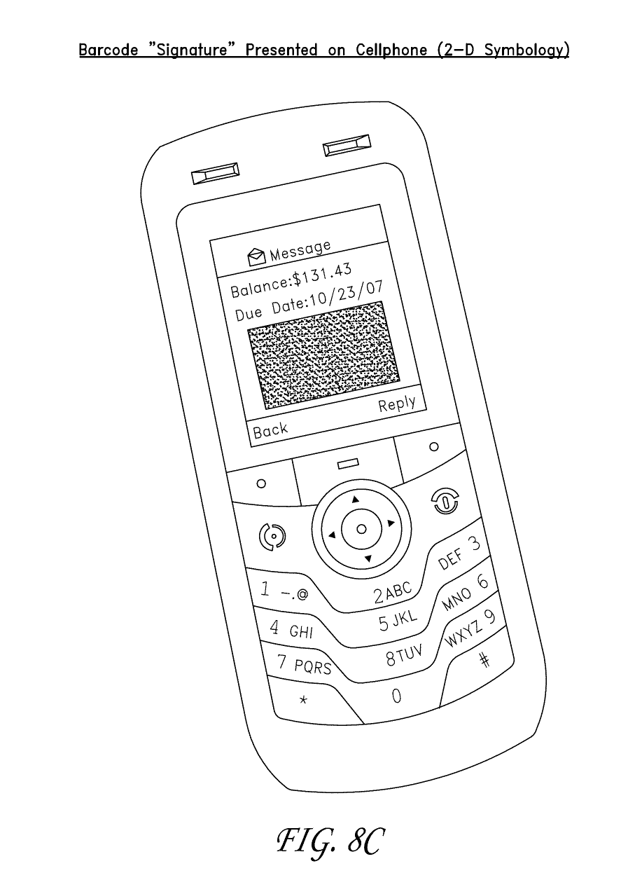

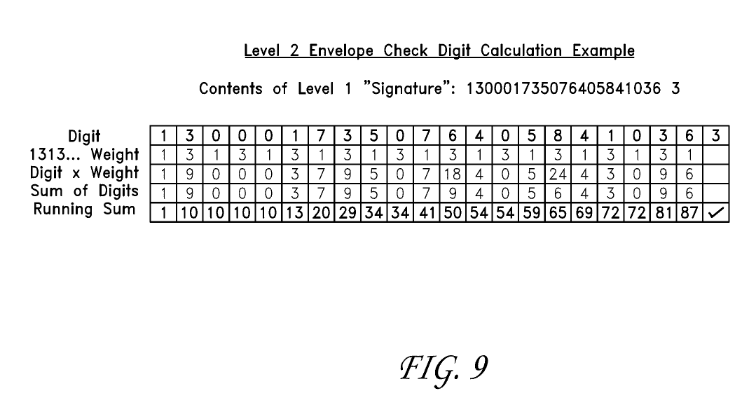

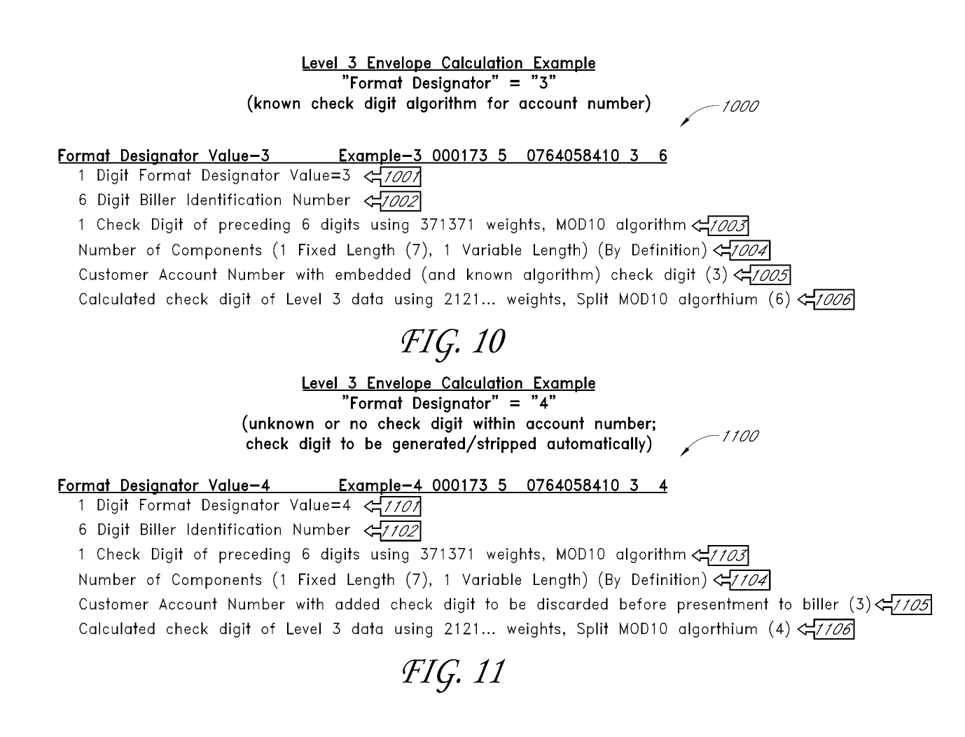

To implement barcode bill payment in the retail environment, where barcoded products abound, Krouse/Meyer teaches the use of an “Algorithmic Signature.” This technique supports an automatic process for recognizing a particular barcode scan as a bill payment, based solely on information contained within the barcode itself. Retail clerks are not asked to take manual steps to distinguish between bills and other items, nor to identify a specific biller. Detecting and validating a barcode bill payment “Signature” in the course of the bill payment process is a key component of Krouse/Meyer, and of all embodiments of the present disclosure. FIGS. 6 through 11 illustrate aspects of “Signature” construction and use; these are described in, Krouse/Meyer.

A significant implementation challenge for any Krouse/Meyer system is the management and dissemination of rules for validating and processing barcode “Signatures.” Many techniques are possible. Example System E utilizes a “Payment Tracking Database” as a repository of such rules, which include such elements as a Biller Directory, “Format Designators,” biller check digit algorithms, “Signature” checksum algorithms, recognition values (often referred to as “Magic Numbers” in the industry), encryption algorithms, data access rules, routing tables, and the many other elements needed to assemble, track, research, and exchange payment data efficiently among independent organizations.

The central management of such rules in a “Payment Tracking Database” allows creation of a single system capable of meeting diverse, evolving requirements. Rather than relying on a single predefined format or group of formats, a set of dynamic rules can let participants meet a variety of changing needs and preferences. As the number of transactions and formats increases over time, it is vital that the appropriate set of internal algorithmic tests be applied to payments. A battery of tests is needed to reduce the risk that a series of random digits might be presented and incorrectly recognized as a valid payment “Signature.” (Those skilled in the art will realize that, when applied to a string of random digits, as opposed to digits that have been key-entered or scanned, a single check digit test can only eliminate a theoretical limit of 90% of false matches. For this reason, the use of distinctive “Format Designators,” recognition strings, multiple checksums, and other algorithmic elements is very important.) The concept of barcode “Signature” levels helps in the construction of such tests. A “Payment Tracking Database” allows for centralized management of all the “Signatures” in use. Aspects of Barcode “Signature” Use

As discussed in Krouse/Meyer and above, the primary goals of the Krouse/Meyer barcode “Signature” design are: a) to identify each detected scanned barcode as being proprietary to a system or method consistent with the present disclosure (in the absence of any other external information); b) to validate all the data element components therein, using mathematical formulae, algorithms, table look-ups, and similar techniques where possible; and c) to provide an easily-portable, monolithic printable image that unambiguously represents a payment destination, suitable for use on invoices, for “Invoice Surrogates,” and for presentation via analogous mechanisms consistent with the present disclosure.

Those skilled in the art will recognize that “Format Designators” used within “Signatures” are related to the computer science technique termed “Magic Numbers,” widely used when attempting to classify unknown data structures. The need for “positive ownership” makes the judicious choice and use of non-ambiguous “Format Designators” a key design goal for any implementation.

Choosing specific methods and procedures for utilizing the “Format Designator” and other “Signature” concepts described in Krouse/Meyer are strictly implementation issues. However, once such choices are made, they must be managed and disseminated among system users. This is an important use for the “Payment Tracking Database” and its component rule definitions. Receipt Data

In a Krouse/Meyer system, the retailer “POS System Host” may generate a printed customer receipt after payment is tendered. Receipt design is generally a retailer implementation decision, and receipt details are beyond the scope of Krouse/Meyer or this disclosure. However, certain elements used in constructing useful payment receipts are intrinsic to the payment process, such as the time of payment, customer identification, biller identification, and a transaction identifier suitable for referencing processing details at a later date. All such data can be assembled and managed effectively by using a “Payment Tracking Database.”

### “POS System Host” Details

The retailer's “POS System Host” is a computer system (or subsystem or other equivalent functionality) that handles point of sale transactions, and in most situations will pre-exist the implementation of an embodiment of this disclosure. To accept barcoded bill payments and to perform the other functions described herein, such a system may be adapted to support (or created to contain) at least two well-defined interfaces: a) at the front end, an interface to checkout scanners; and b) at the back end, an interface to the bill payment infrastructure described in this disclosure, which in Example System E includes a “DCNI” and a transaction collection system, but which may be implemented via these or other components, or may themselves be integrated within a point of sale or other system.

When a bill payment barcode “Signature” has been scanned at a checkout scanner, after presentation of a bill remittance stub or “Invoice Surrogate,” the retail “POS System Host” is responsible for determining that this scan represents a customer bill payment, rather than the UPC or other barcode of some unrelated product. Krouse/Meyer describes mechanisms for implementing this test, which may involve “sieve” processing on the POS platform, use of recognition sequences, or other techniques. Regardless of where such barcode tests are performed, these must match a common set of “Signature” definitions. In Example System E, those definitions and associated rules are managed within a “Payment Tracking Database,” which is accessed directly or indirectly by the “POS System Host” or by the other platforms where format-specific logic is required.

As bill payments are processed by the retail “POS System Host,” they are submitted for payment processing. As described in Krouse/Meyer and herein, this may be done by such mechanisms as: a) a “pass-through” operation through the “DCNI”; b) temporary storage of transactions on the “POS System Host” for later submittal; c) temporary storage of transactions on the “DCNI” for later submittal; d) the use of some other platform in addition to or in place of the “DCNI”; or e) direct submittal from the “POS System Host” to a “Transaction Collection System” or payment system, which may or may not have a “guaranteed delivery” capability. Regardless of what latency occurs, a design goal for any embodiment would be the guaranteed delivery and settlement of all such transactions, so that a customer's tendered payment is confidently expected to reach the biller. As described herein, guaranteed delivery can be implemented through a wide range of techniques that are well-understood in the industry. Regardless of the delivery techniques chosen, suitable payment event details can be captured throughout this process by a “Payment Tracking Database,” to amass a true record of processing details. A “Payment Tracking Database” may also be used in performing a number of standard support functions, functions that may be incorporated in or interact with a given retailer's payment, reconciliation, administrative, or other processes. Examples include: validating the Biller ID, retrieving the biller name, retrieving other biller data (such as a telephone number), adding a transaction, voiding a transaction, retrieving format or processing rules (such as bar code “Format Descriptors” or check digit algorithms), retrieving or printing detail or summary data (e.g. on demand or using daily, weekly, or other cycles), or setting or reading “DCNI” operational configuration parameters.

### System Component Details

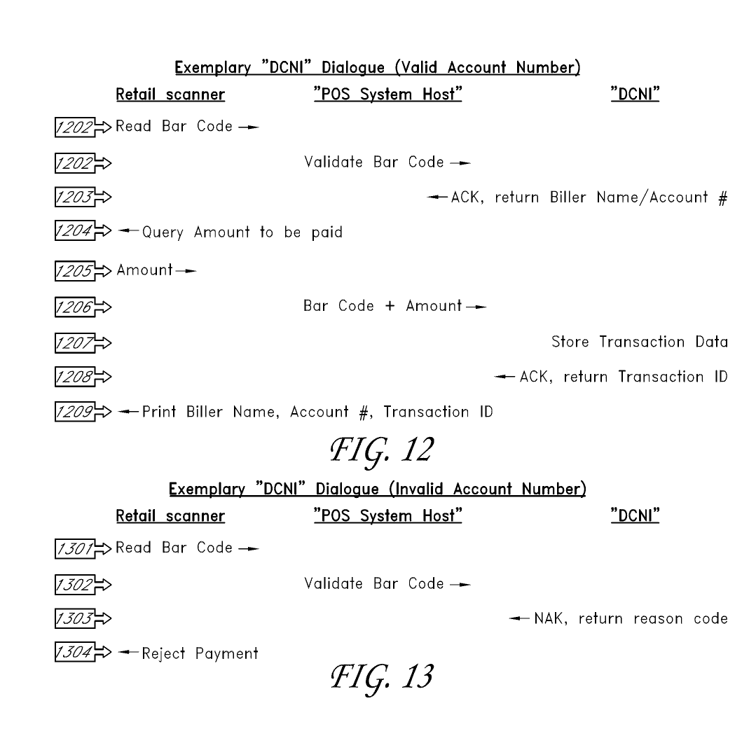

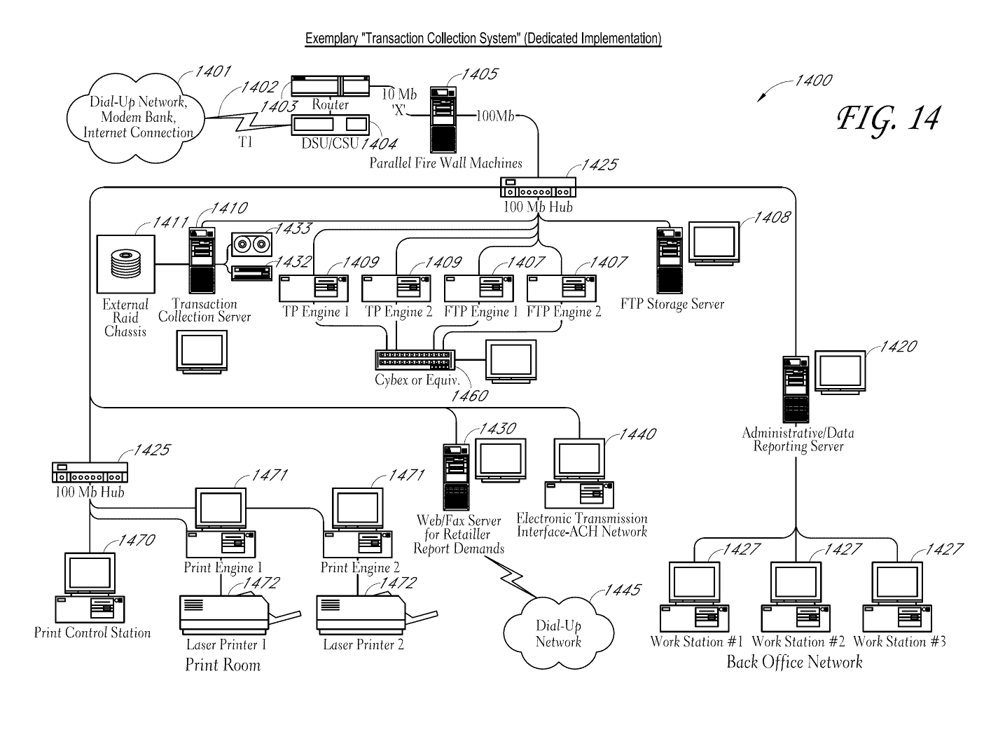

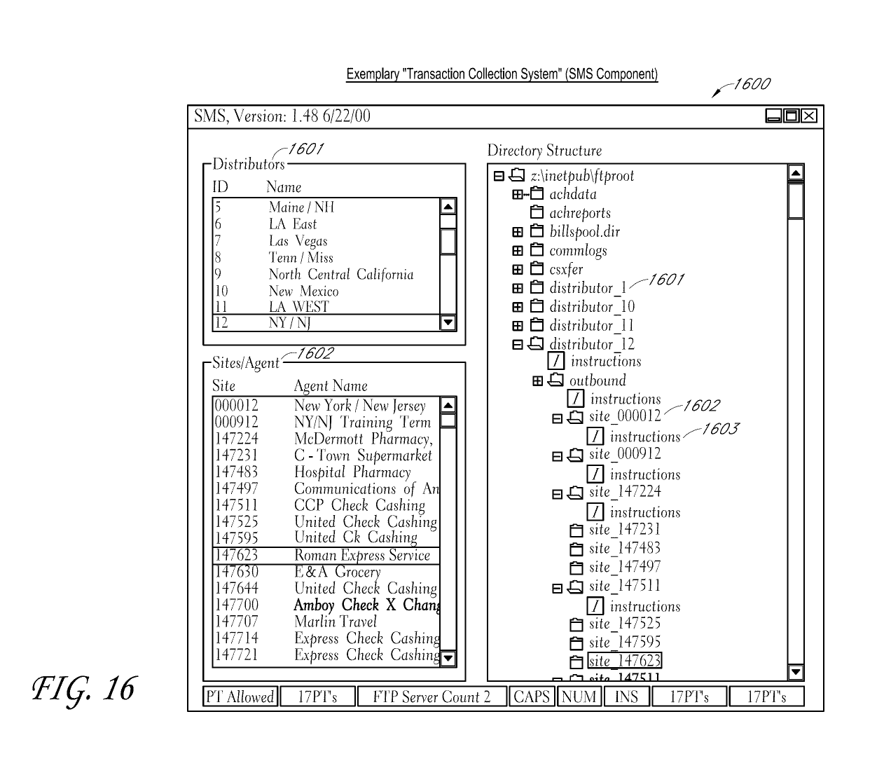

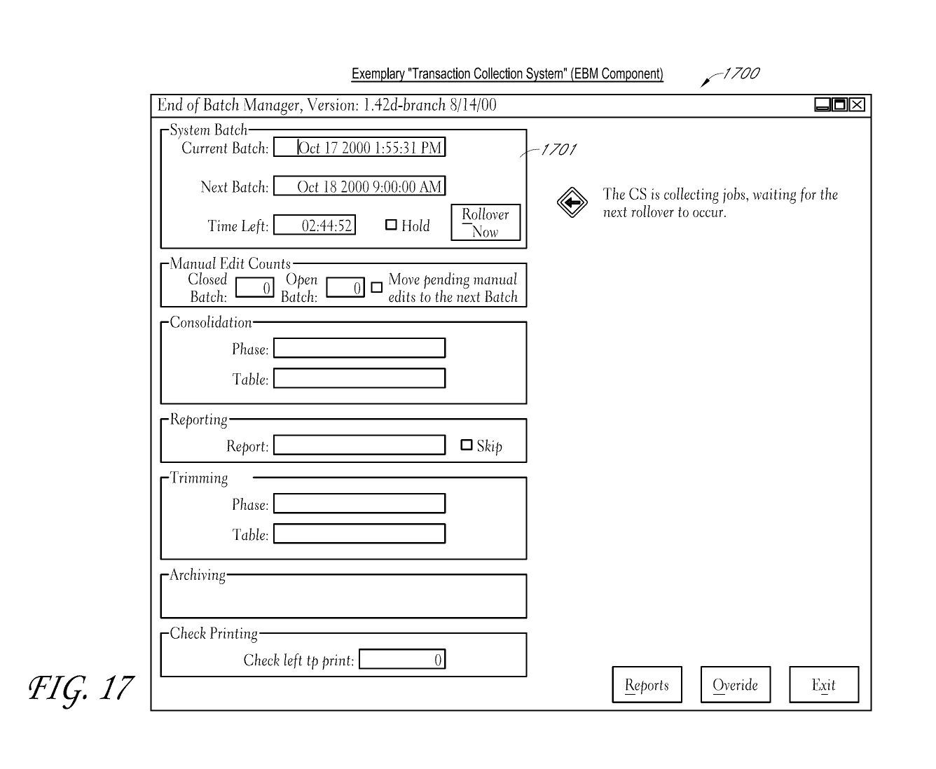

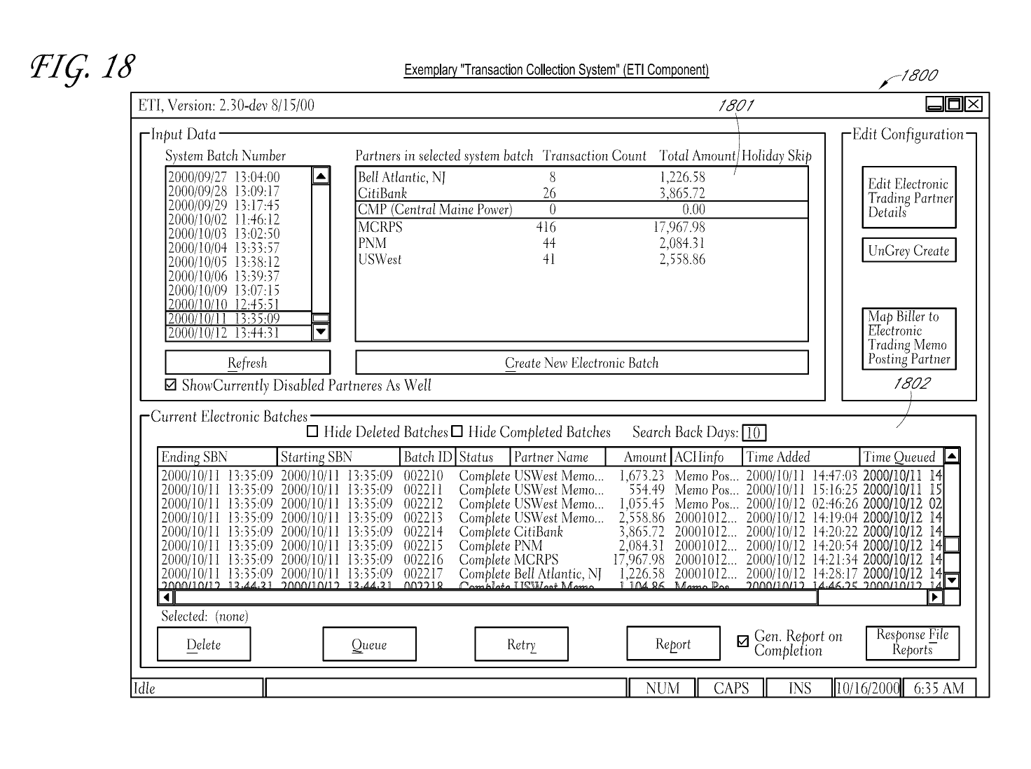

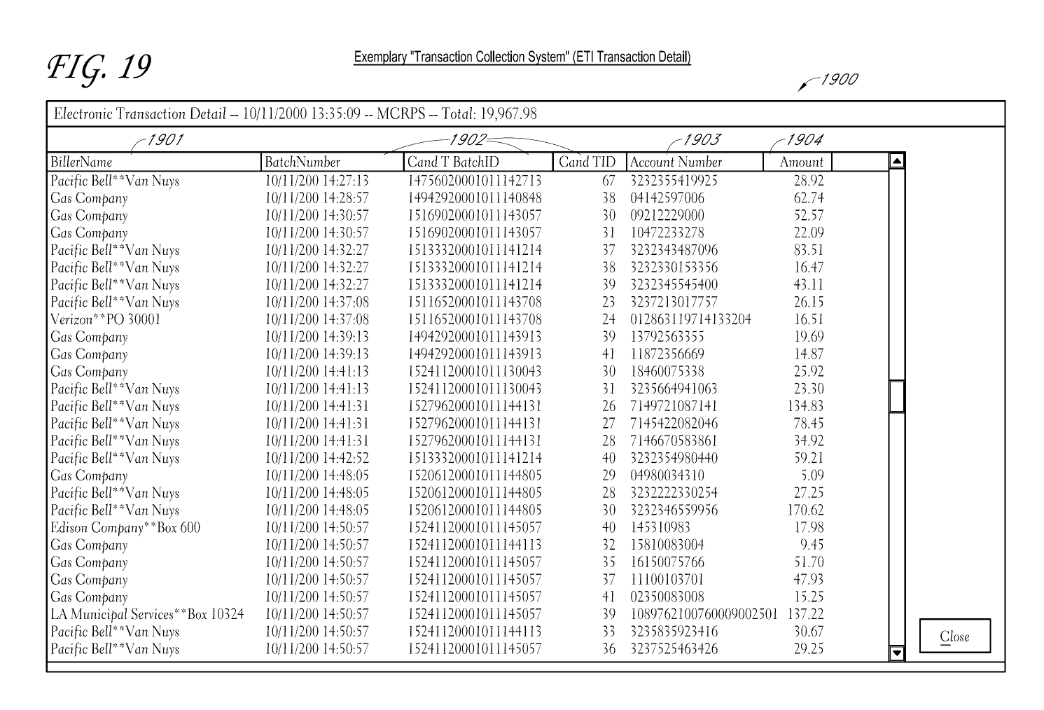

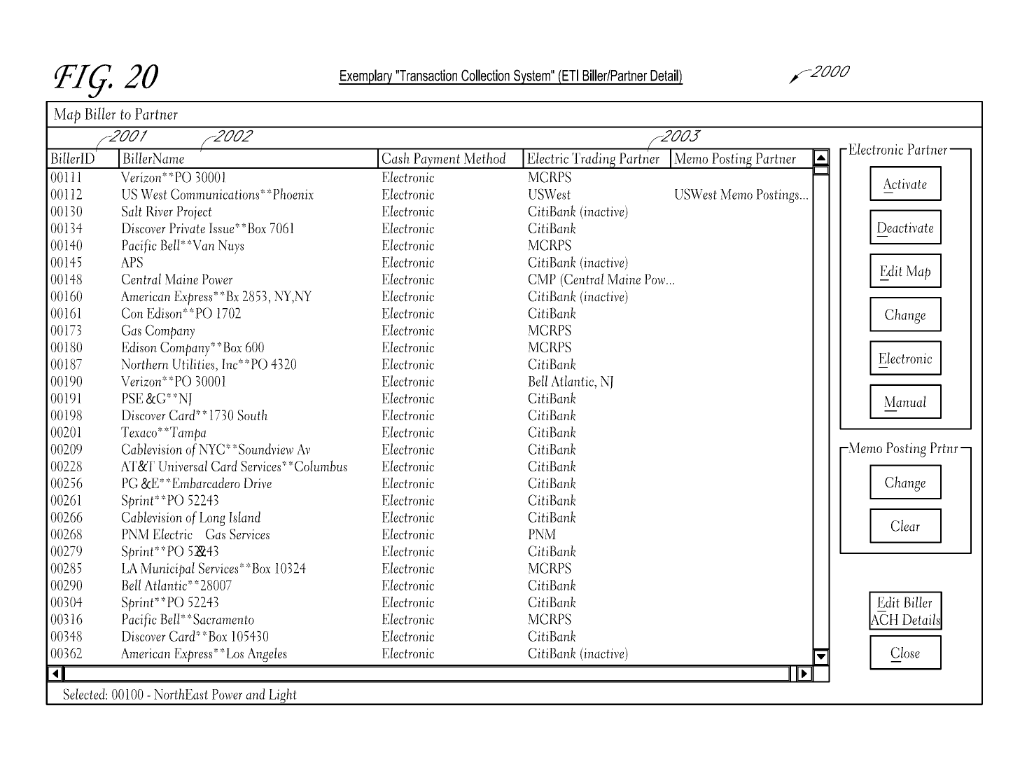

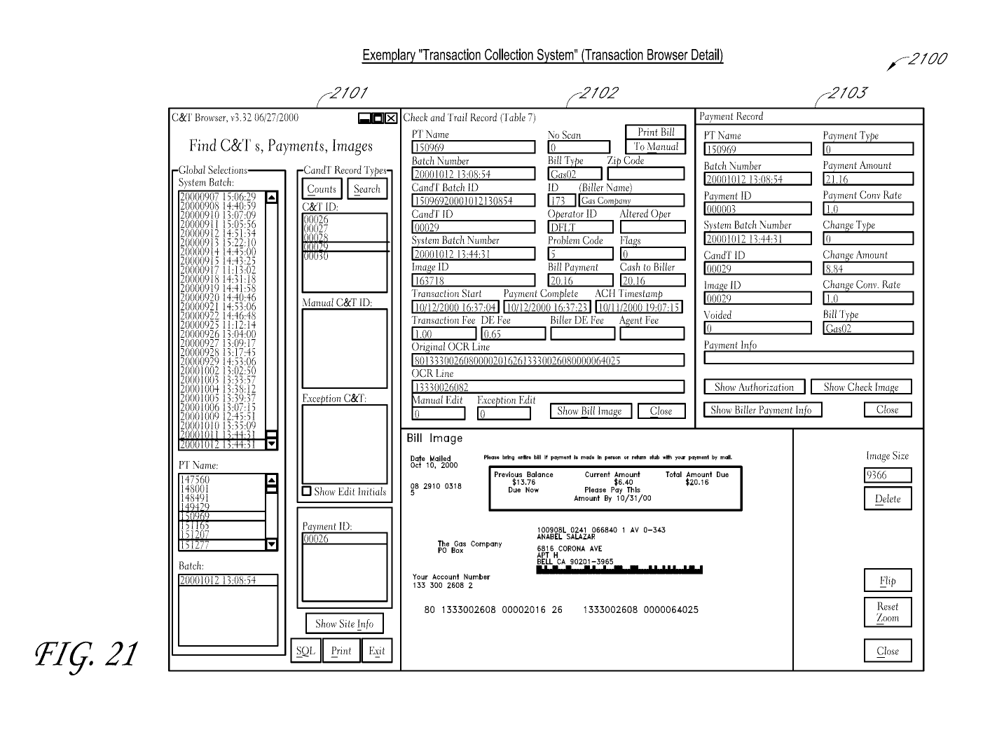

Krouse/Meyer describes a variety of alternative strategies for implementing the various system components that process payment transactions after presentation to a retailer. FIGS. 12 through 21 illustrate various processing steps and implementation options, and are described in Krouse/Meyer. Such choices are irrelevant to the possible embodiments of this disclosure, provided that normal industry practices are utilized to avoid such risks as single-point failures.

### Improved Embodiments for Electronic Commerce and Money Transfer

Krouse/Meyer describes a biller/retailer/consumer payment system, modeled on traditional recurring bill payment processing, and which is also extended to address other scenarios involving consumer-to-consumer and business-to-business transactions. The present disclosure is equally applicable to such embodiments. The presence of a “Payment Tracking Database” enhances these services, by providing a uniform repository for payment rules and processing events. The “Mediating Technologies” and other elements described herein allow support for a broad range of transaction types and participants.

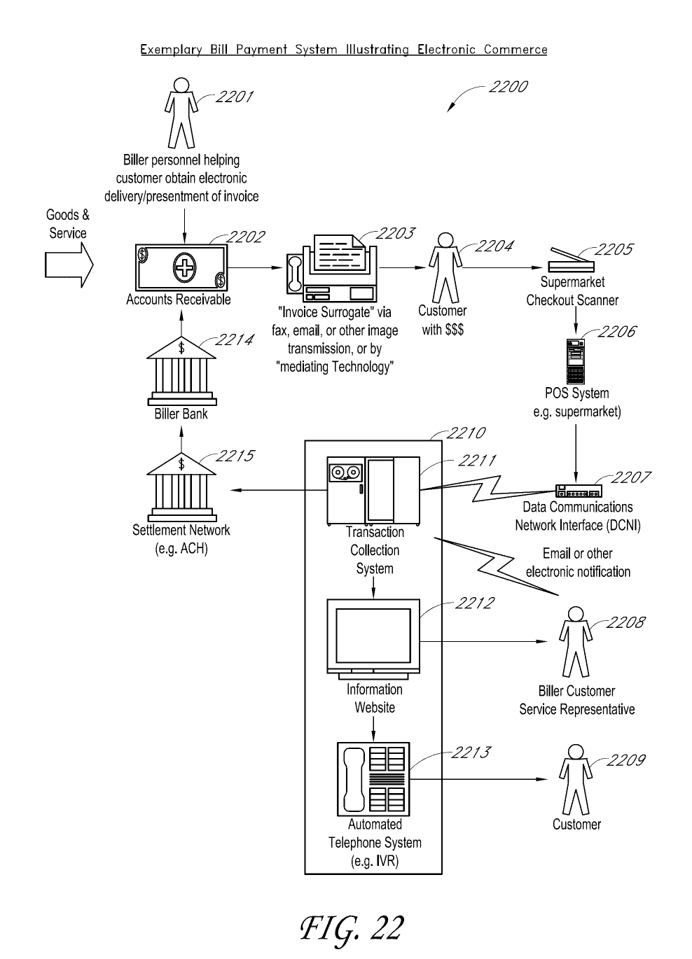

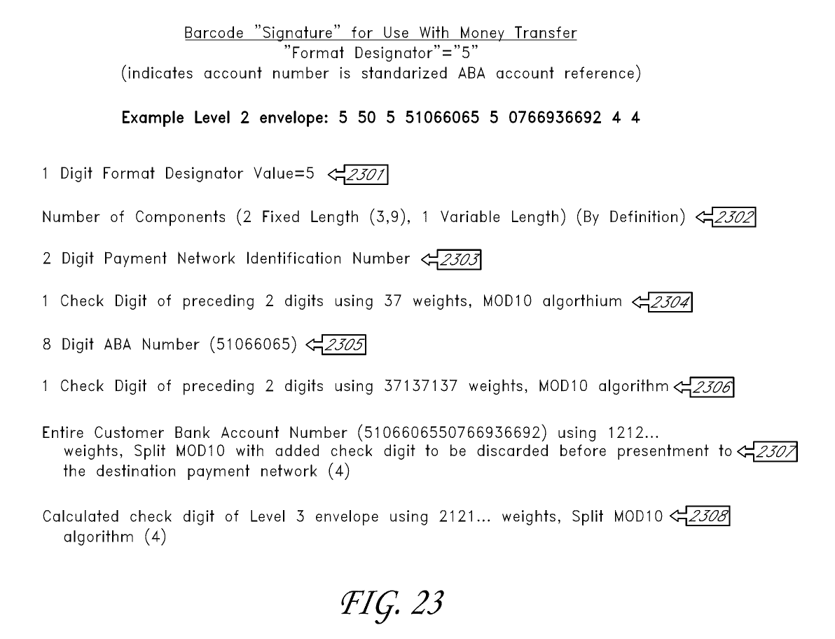

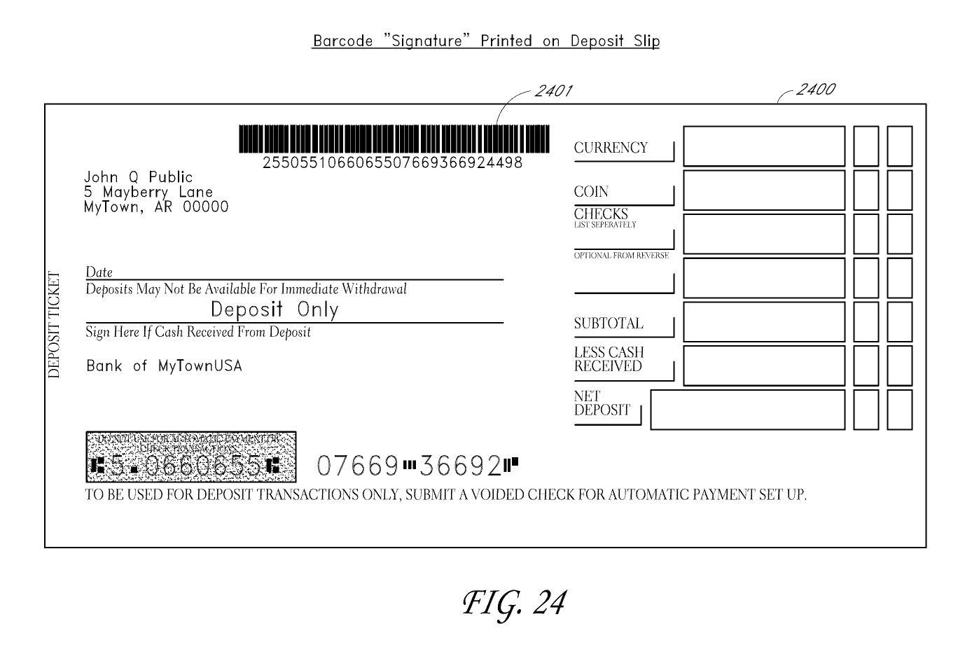

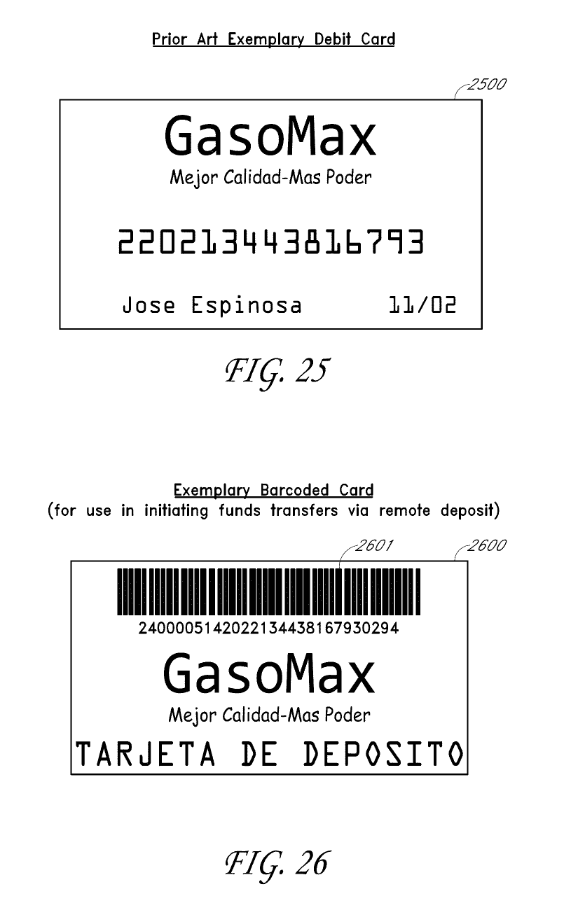

FIG. 22 illustrates an example embodiment of an improved barcoded bill payment based system that utilizes an “Invoice Surrogate” for on-demand bill presentment, such as with electronic commerce. The system is similar to Example System E (shown in FIG. 5A), but the focus here is on delivery of invoices via electronic means, such as by fax, e-mail, website, or cell phone. In overview, the customer 2204 uses this embodiment to present an “Invoice Surrogate” 2203 at a retail location 2205, e.g. by first printing its image at a computer, or by presenting a cell phone screen at the checkout lane. Payment information and payment credits are returned to the biller electronically, using the same basic mechanisms described for Example System E.

For greater efficiency in an electronic setting, the embodiment shown in FIG. 22 augments certain technical elements shown in FIG. 5A. For example, the biller accounts receivable and USPS consumer remittance systems are shown to use an enhanced interface for retrieving invoice statement images 2201 and 2203. This interface could be provided either for consumer or for biller use. When activated, it would create a barcoded “Invoice Surrogate” image 2203, and deliver it to the consumer 2204 within a time frame of seconds to minutes.

Similarly, this embodiment enhances the “Transaction Collection System” 2211 to facilitate prompt transaction lookup by consumers or billers for research or customer support purposes, allowing rapid confirmation of payments within minutes of a retail transaction. This capability is shown as utilizing a website 2212 and an automated telephone system 2213, e.g. one using interactive voice response (IVR). These information interfaces would help ensure that the speed of information access remains comparable to the accelerated speed of invoice presentment and payment.

This embodiment includes a mechanism for offering special payment services, such as expedited payment. When the consumer 2204 presents the bill image 2203 for payment, the retailer system may be configured to offer the consumer a variety of options, e.g. enhanced timing or features for additional fees. This capability is consistent with Example System E, but as discussed below such features are of special importance with a system designed for rapid electronic bill presentment, such as shown in, FIG. 22. For example, the “Transaction Collection System” 2211 feeds transaction data to a website application 2212 and telephone response system 2213, which are used by biller personnel 2208 or customers 2209 to access information about active payments. These interfaces access the same payment data that in earlier example embodiments are provided to billers via automated data feeds.

In this embodiment, website data access allows a more comprehensive set of information tools, serving a larger potential user community, and delivering a greater level of detail with lower processing latency. A typical performance goal for such an embodiment would be to allow billers or customers to obtain payment confirmation within fifteen minutes after a given payment has been tendered at a retailer. Retrieval would be accomplished by specifying either a transaction identifier, as printed on a receipt, or by entering a suitable combination of other search criteria (subject to appropriate security and privacy restrictions that will be obvious to those skilled in the art).

In addition, this embodiment illustrates an electronic notification pathway between the “Transaction Collection System” 2211 and biller personnel 2208 by which selected payments might be flagged and tracked. For example, a past-due account threatened with a 48-hour disconnect notice might be flagged for an email notification of payment, to ensure that an unnecessary field action can be avoided if a last-minute payment is made.

Expedited and other special services would primarily be a business matter to be resolved between retailer and biller. For example, a biller and biller might jointly offer a service whereby customers can pay an additional fee for email notification of payment posting to both consumer and biller. A customer faced with a 48-hour disconnect notice might be encouraged or required by the biller to purchase this service, to avoid being liable for a reconnection charge based on some cutoff time. (Such requirements may have regulatory consequences.) A variety of service level guarantees might be offered, analogous to those with package delivery services: same day, next morning, next afternoon, etc. Note that these services might affect such factors as: a) the biller's posting time (i.e. the time the biller is notified of payment); b) the priority given the payment by the biller; or c) the actual time that funds will arrive in the biller's account. Such service details are commercial matters, to be arranged among the transaction participants; they have obvious technical ramifications, such as the provision of an email notification pathway as shown in FIG. 22, or the segregation and acceleration of expedited versus non-expedited payments as they traverse the various system elements, such as retail “POS System Host” 2206, “DCNI” 2007, “Transaction Collection System” 2211, and ACH network 2215.

It should be stressed that the enhanced embodiment shown in FIG. 22 makes it possible for an Internet merchant to accept cash and anonymous payments for goods and services. Presently, there is no simple mechanism available by which such business can be transacted; the biller and consumer must instead use some other payment medium, and must trust each other. This enhanced embodiment allows anonymous payments to be made at a retailer location, eliminating the need for end-to-end trust to complete a transaction. The retailer need only trust the consumer's medium of payment (e.g. cash), and the biller need only trust the banking system's ability to deliver funds (or may simply wait for electronic delivery of good funds).

Krouse/Meyer also describes embodiments that enable the transfer of funds between individuals or small businesses utilizing barcoded “Invoice Surrogates.” The present disclosure can be applied to such systems, bringing to them the additional benefits of a “Payment Tracking Database” and the mediating technologies herein described. By their nature, money transfer applications have a particular need for comprehensive mechanisms for auditing, privacy, provider flexibility, and accountability. All these areas are enhanced by the present disclosure.

### Additional Alternative Embodiments

It should be recognized by those skilled in the art that, although the foregoing descriptions refer to the use of such mechanisms as e-mail or facsimile, other methods of transmission are consistent with this disclosure. Possible embodiments might utilize such technologies as facsimile transmission to or from a computer, facsimile machine, e-mail, file transfer protocol (FTP/SFTP), hypertext markup language (HTML), extended markup language (XML), hypertext transport protocol (HTTP/HTTPS), Web Services (SOAP/WDSL/XML, etc.), modems, optical transmission, infrared transmission, the Internet (used in either public or private forms, and via its various protocols such as TCP, UDP, DNS, SSL, etc.), wireless communication mechanisms such as BlueTooth, a wide-area network (WAN), a local-area network (LAN), a virtual private network (VPN), diskette, memory card, USB Flash Drive, any other removable storage medium, or any other mechanism by which a barcoded “Signature” or an “Invoice Surrogate” could be presented to a consumer or third party for subsequent use at a retail location. Similarly, a barcode “Signature” for use within an “Invoice Surrogate” can be created through the use of a range of “Mediating Technologies,” e.g. translation between barcode symbologies, translation of text from a paper or electronic invoice, database lookup to convert a transaction “Serial Number” to an account number, or any other mechanism by which a barcoded representation of a payment transaction could be created. System connections might also utilize the Federal Reserve NACHA Automated Clearing House (ACH) Network or other networks, including existing and proposed commercial payment processors and consolidators.

Although certain embodiments of Krouse/Meyer and the present disclosure have been described in examples that utilize a Code 128 barcode, other codes could be used. Those skilled in the art will appreciate that the principles involved in Krouse/Meyer and the present disclosure apply equally to all types of barcodes, including non-128 barcodes, 2-D glyphs of various kinds, and in particular to both linear and nonlinear barcodes. Examples of commonly used linear barcodes include the GSI-Databar family, Code 39, Code 93, and EAN 13. Examples of non-linear barcodes include stacked barcodes (such as Code 16K) and 2D or matrix barcodes (such as DataMatrix). The common characteristic of all of such codes is that they are all machine-readable images (i.e., computer-readable), and thus can be used in implementing the bill payment systems described herein.

Those skilled in the art will recognize that the servers and their various components, as well as any other technical components described herein, may be implemented in software, hardware, virtualized services, or a combination of all, and may be separate components or be integrated into other components as described above. Likewise, the processes described herein may be separate or combined, and may run on common, shared, virtualized, or separate machines, and may be implemented with the use of integrated or separate software modules.

Additionally, the scanning of barcodes, in methods consistent with the disclosure, may be performed using a range of technologies, including without limitation: wand or handheld scanning devices, scanning devices mounted to or near a point of sale system, flatbed or sheet-fed image scanners, cameras, cameraphones, and other such scanning and imaging devices. Moreover, such devices may in turn be coupled to other devices, including without limitation: computers, cash registers, kiosks, point of sale systems, terminals, checkout stations, servers, network appliances, routers, hubs, or protocol converters; or alternatively, integrated therein. In addition, a scanning device or other element consistent with the disclosure may be coupled to or integrated into such devices as, without limitation: a PDA, handheld or pocket computer, mobile telephone, or other portable, wireless, or computerized device.

Thus, for example, in a configuration consistent with this disclosure (Example Scenario S), a consumer could use a mobile telephone or similar device to make barcoded payments that would result in charges that would accrue to a credit or debit or other account corresponding to that device; and analogously (Example Scenario T), such an account could be used as the destination for barcoded payments that may be made by that consumer or by others. In the former case, the device would be used to display or transmit an “Invoice Surrogate” which in turn would direct the flow of funds away from the account in question. In the latter case, a separate “Invoice Surrogate” (e.g. a printed document) would identify the account in question as the payment destination. Finally, in a configuration consistent with this disclosure (Example Scenario U), a consumer could use a cameraphone or similar device capable of scanning a barcode image to read and interpret an “Invoice Surrogate” (such as a printed document or computer display) that represents a bill, and thereby effect payment of said bill using a credit or debit or other account corresponding to that device. In this case, payment is made using the same process described above for Example Scenario S, but instead of using the device to display an “Invoice Surrogate” that would be scanned at a retail location, the device is itself used as the scanner, and the cell phone network operator is serving the role of the retailer in effecting payment.

It will be appreciated by those skilled in the art that the functional components of the above described embodiments of the system of the present disclosure are each presented in terms of specific illustrative elements, such as distributed computer program processes, data structures, databases, dictionaries, other stored data, conventional general purpose computers (e.g. IBM-compatible, Apple Macintosh, and/or RISC microprocessor-based computers), mainframes, minicomputers, conventional telecommunications methods (e.g. modem, DSL, T-1, satellite, and/or ISDN communications), memory storage means (e.g. RAM, ROM), storage devices (e.g. computer-readable memory, disk array, direct access storage), and network hardware and software components (e.g. LAN/WAN network backbone systems and/or Internet). This level of specificity notwithstanding, other types of technology, including other computers, data storage strategies, or communications methods may be used instead, without departing from the present disclosure, and it is presumed that a skilled practitioner would always choose the best available current implementation technologies, where appropriate, in preference to elements that may have been specified herein by way of example.

In particular, the disclosure as described herein may be embodied in one or more computers, residing on one or more server or other systems, having input/output access enabled via the use of appropriate hardware and software (e.g. personal and/or mainframe computers), provisioned with network communications hardware and software (e.g. CGI-based, FTP/SFTP, HTML, XML, WDSL, SOAP, Internet browser software, and/or direct real-time TCP/IP interfaces accessing real-time TCPIIP sockets). Such mechanisms would be chosen to permit human users to send and receive data, or to allow unattended execution of various operations, via real-time and/or batch-type transactions and/or at user-selectable intervals. Likewise, the servers and other components utilized in embodiments consistent with the present disclosure may include remote Internet-based servers accessible through conventional communications channels (e.g. conventional telecommunications, broadband communications, or wireless communications) using conventional browser software (e.g. Mozilla Firefox, Netscape Navigator™, or Microsoft Internet Explorer™), in which case the embodiments described herein would be appropriately adapted to include such functionality. Additionally, those skilled in the art will recognize that the various components of the example systems described in the present disclosure may be remote from one another, and may further include appropriate communications hardware/software and/or LAN/WAN hardware and/or software to accomplish the functionality herein described. Alternatively, a system consistent with the present disclosure may operate completely within a single machine, e.g. a mainframe or other computer, rather than as part of a network.

Moreover, each of the functional components described in the exemplary embodiments of the present disclosure may be implemented as one or more distributed computer program processes, running on one or more conventional general purpose computers, networked together by conventional networking hardware and software. Alternatively, each of these functional components may be implemented by running distributed computer program processes (possibly utilizing relational or other database engines such as IBM DB2™, Microsoft SQL Server™, Sybase SQL Server™, or Oracle™ database managers, and/or external interfaces such as ODBC that may link to such databases) on networked computer systems (e.g. comprising mainframe and/or symmetrically or massively parallel computing systems such as the IBM z/Series™ or HP 9000™ computer systems), including appropriate mass storage, networking, and other hardware and software as appropriate for these functional components to embody the stated functions. Moreover, such computer systems may be located at a single facility or geographically distributed and connected together via appropriate wide- and local-area network hardware and software.

Primary elements of the disclosure may be server- or mainframe-based, and may reside on hardware supporting an operating system such as Microsoft Windows NT/200×/XP/Vista™, UNIX/Linux, or a mainframe system such as z/VM. Clients of these systems may include computers with windowed or non-windowed operating systems, e.g. Apple o S/XTM, Microsoft Windows 95/98/NT/ME/XP/200×/Vista™, or MS-DOS™, a UNIX/Linux Motif workstation platform, a UNIX/Linux Gnome or KDE platform, a non-windowed UNIX/Linux platform, a Palm™, Windows CE™-based or other handheld computer, a network- or web-enabled mobile telephone or similar device, or any other computer or terminal capable of TCP/IP or other network-based based interaction with the servers. The term “network” as used in this disclosure is applied generically to a range of communications media and technologies, and may include wired or wireless networks, or a combination thereof the term “network” is also used in a different sense to refer to a business or infrastructure providing certain kinds of services such as payment processing or funds transfer. Both of these uses are in common industry parlance, and the term is not given intended to be given any special meaning by this disclosure.

Alternatively, the aforesaid server- or mainframe-based functional components may be embodied by a plurality of separate small-computer processes (possibly implemented via dBase™, Xbase™, MS Access™, or other database management systems or products) running on personal computers or comparable equipment (such as Apple Macintosh, IBM-type PCs using Intel Pentium™ or RISC microprocessor or other CPO s), networked together via appropriate networking hardware and software, and including such other additional appropriate hardware and software as is necessary to permit these components to achieve the stated functionalities. In such an alternative configuration, since such personal computers may be unable to run full-scale relational database engines of the types presented above, a non-relational flat file “table” may be included in at least one of the networked personal computers to represent at least portions of data stored by a system consistent with the present disclosure. These personal computers may run windowed or non-windowed operating systems, e.g., UNIX/Linux, OS/X, or Microsoft Windows 95/98/NT/ME/200×/XP/Vista™ operating systems.

The functional components of a system consistent with the present disclosure may also include a combination of the preceding two illustrative configurations (i.e. server- or mainframe-based, and small-computer-based), e.g. by computer program processes running on a combination of personal computers, RISC systems, mainframes, symmetric or parallel computer systems, and/or other appropriate hardware and software, networked together via appropriate wide- and local-area network hardware and software.

The enumeration within this disclosure of various hardware and software platforms that would be consistent with this disclosure is intended to provide examples, rather than create limitations. Those skilled in the art will recognize that the particular choices of hardware or software products, the use of commercial versus open-source software, the choices of operating systems, languages, protocols, frameworks, and other technical elements mentioned here are strictly implementation decisions. Such decisions would be made to facilitate the creation of a given embodiment, rather than to establish boundaries or parameters for that embodiment.

As those skilled in the art will recognize, possible embodiments of the disclosure may include such security mechanisms as: a) one- or two-way data encryption, digital certification, public key encryption, or n-factor authentication, where such mechanisms might be applied to data as it is input, output, transferred, processed, or stored; and b) password or PIN number protection, use of a semiconductor, magnetic or other physical key device, biometric methods (including fingerprint, nailbed, palm, iris, or retina scanning, handwriting analysis, handprint recognition, voice recognition, or facial imaging), or other security measures known in the art. Any such security measures may be implemented singly or in combination, in one or more systems or methods of the disclosure.

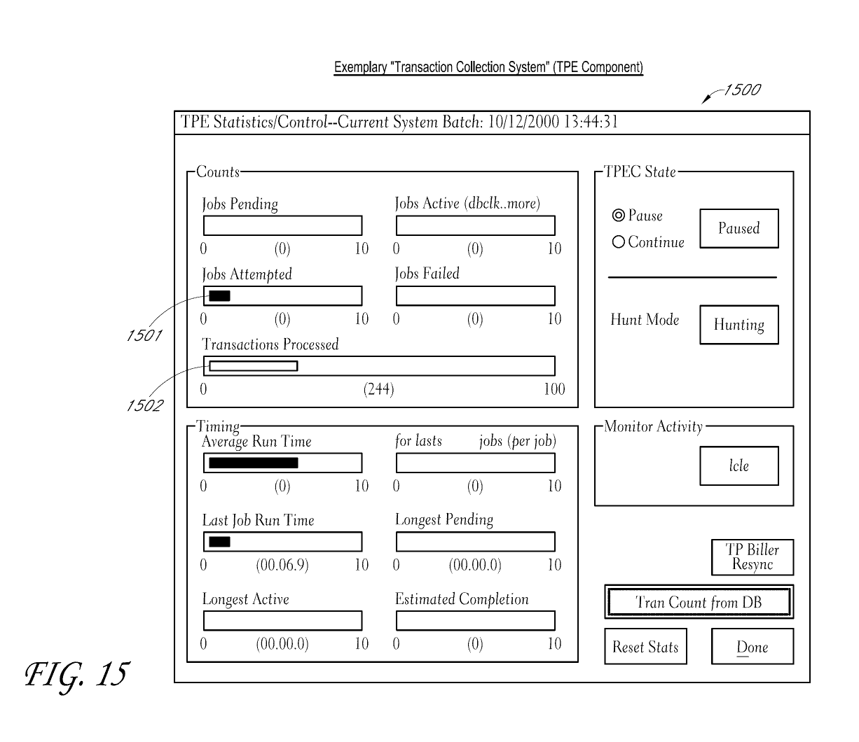

Source code for systems comprising an embodiment of this disclosure may be written in an object-oriented or non-object-oriented or other programming language, using relational, flat-file, or other databases, or no databases, and may include the use of arbitrary programming languages and related standards, including without restriction C, C++, C#, D, Java, JavaScript, HTML, XML, WDSL, SOAP, Perl, PHP, Python, Ruby, UNIX shell scripting, assembly language, Fortran, Pascal, Visual Basic, or QuickBasic. It is further noted that the screen displays illustrated herein at FIGS. 15-21 are provided by way of example only, and are not to be construed as limiting the disclosure or any component thereof to the exemplary embodiments.

It is also contemplated that the system and method described herein may be implemented as part of a business method, wherein payment is received from users, which might include customers, retailers, and/or billers, who employ the inventions described in the present disclosure, and where said employment may be direct and visible, or indirect and hidden. In other words, the user-level features described in the above embodiments mayor may not be made visible to such users, who may simply perceive an overarching business relationship that is predicated on the existence of such services. Such users may pay for their conscious or unconscious use of the services enabled by the disclosure, based on such measures as: a) the number of files, messages, bills, or other units of data sent or received or processed; b) bandwidth used, on a periodic (weekly, monthly, yearly) or per-use basis; or c) in a number of other ways consistent with the disclosure, as will be appreciated by those skilled in the art.

Furthermore, although embodiments of the present disclosure have been described in the context of bill payment transactions, electronic commerce, and money transfers, those skilled in the art will recognize that the illustrative systems described can apply equally to other forms of monetary transactions. For example, the systems and methods described herein can easily be adapted to consummate transactions involving gift cards, credit cards, debit cards, prepaid cash cards, smart cards, and other forms of electronic monetary transactions, including bank account transactions such as deposits and the replenishment of Internet wallets.

Those skilled in the art will recognize that the present disclosure may be implemented in hardware, software, or a combination of hardware and software. Finally, it should also be appreciated from the outset that one or more of the functional components may alternatively be constructed out of custom, dedicated electronic hardware and/or software, without departing from the present disclosure. Thus, the present disclosure is intended to cover all such alternatives, modifications, and equivalents, as may be included within the spirit and broad scope of the disclosure as defined only by the hereinafter appended claims.

What is claimed is:

1. An improved financial transaction device comprising barcoded information incorporating one of a plurality of algorithmic signatures, the signature being configured to permit at least one party involved in a financial transaction to store pertinent data in a multi-organizational payment tracking database.

2. The device of claim 1, wherein the signature comprises elements capable of referencing some of the pertinent data.

3. The device of claim 1, wherein the signature comprises a payment tracking identifier capable of uniquely referencing a single financial transaction and some of the pertinent data.

4. The device of claim 1, wherein the data comprises information reflecting one or more of the transaction, the signature, a party involved in the transaction, or any combination thereof.

5. The device of claim 1, wherein the data further comprises at least one rule that applies to at least one element of the data.

6. The device of claim 5, whereby the rule enables a party involved in the transaction to assess an aspect of the format, interpretation, or processing of the transaction or of the data.

7. The device of claim 6, whereby the rule at least in part controls the ability of a party involved in the transaction to access or to modify the data.

8. A format signature for device recognition, the signature comprising a substantially unique pictographic image configured to reflect a substantially unique set of visual features appearing in a two-dimensional arrangement on the device.

9. The signature of claim 8, wherein the signature is configured to be scanned electronically permitting a processing system to recognize the device.

10. The signature of claim 9, whereby the signature is configured so that the device may be recognized by comparing the image with a database of signatures.

11. A database of signatures for device recognition comprising a plurality of signatures according to claim 8.

12. The database of claim 11, wherein the signatures are arranged into a pictographic alphabet.

13. A data transfer device comprising an open-ended two-dimensional series of alphanumeric characters or other distinct symbols, the series being derived from source data through an automated encoding process based on an encoding signature, whereby a corresponding decoding process installed on an automated device may reliably use the encoding signature to reconstitute the source data through visual processing of the series and visual recognition of the distinct symbols.

14. The device of claim 13, wherein the automated device comprises a scanner and means for optical character recognition.

15. The device of claim 13, further comprising a rule or plurality of rules that allow access to an automated database in a form suitable for updating the automated database.

16. The device of claim 15, wherein at least one rule represents at least one element in a library used by the automated database.

17. The device of claim 16, wherein the element represents a format signature for device recognition, the signature comprising a substantially unique pictographic image configured to reflect a substantially unique set of visual features appearing in a two-dimensional arrangement on the device, whereby a scanning system can automatically recognize an instance of the device by electronically comparing the instance with a plurality of said signatures arranged into a pictographic alphabet.
